(19) United States
(12) Patent Application Publication
(10) Pub. No.: US 2003/0063241 A1
(43) Pub. Date: Apr. 3, 2003

(54) Opposite substrate for liquid crystal display panel, liquid crystal display panel, and method of fabricating them

(75) Inventors: Kenji Matsumoto, Tokyo (JP); Kenji Tanaka, Tokyo (JP); Kazunori Ono, Tokyo (JP)

Correspondence Address: SUGHRUE MION, PLLC, 2100 PENNSYLVANIA AVENUE, N.W., WASHINGTON, DC, 20037, US

(73) Assignee: HOYA CORPORATION

(21) Appl. No.: 10/254,632

(22) Filed: Sep. 26, 2002

(30) Foreign Application Priority Data
Sep. 28, 2001 (JP) 302849/2001
Sep. 28, 2001 (JP) 303023/2001

(51) Int. Cl. G02F 1/1333

(52) U.S. Cl. 349/110

(57) ABSTRACT

In an opposite substrate for a liquid crystal display panel, a black matrix is formed on a light-transmitting substrate on a side thereof confronting a driving substrate. The black matrix has a high reflection film on a side thereof facing the light-transmitting substrate, and a low reflection film on a side thereof facing the driving substrate. Between the high reflection film and the low reflection film, there is provided a mixed region where components of the high reflection film and the low reflection film exist mixedly. The high reflection film may be added with an element for suppressing the generation or progress of migration, thereby to prevent occurrence of a pinhole in the black matrix.

### BACKGROUND OF THE INVENTION

1. Field of the Invention

The present invention relates to a liquid crystal display panel to be used as a light bulb in a liquid crystal projector or the like (hereinafter simply referred to as “liquid crystal display panel”), an opposite substrate for the liquid crystal display panel, and a method of fabricating them, and more specifically, relates to a light-shielding film formed on an opposite substrate for a liquid crystal display panel. Herein, it is to be noted that the opposite substrate may be called a counter substrate or an opposing substrate.

2. Description of the Related Art

Generally, in a liquid crystal display panel, strong projected light is entered from the side of an opposite substrate that is disposed so as to confront a driving substrate (TFT array substrate) with a liquid crystal phase being an electro-optic substance interposed therebetween.

If this strong projected light enters channel forming regions comprising a-Si (amorphous silicon) films or p-Si (polysilicon) films of TFTs disposed on the driving substrate, photoelectric current is generated in those regions due to the photoelectric transfer effect to deteriorate transistor characteristics of the TFTs. Therefore, in order to suppress this phenomenon, light-shielding films arranged in a matrix form, called a black matrix, are generally formed on the opposite substrate at positions confronting the respective TFTs.

Such a black matrix is made of a metal material such as Cr (chrome), a resin black in the form of a photoresist with dispersed carbon, or the like, and exhibits functions of improving the contrast and preventing the mixture of color materials at color filters, in addition to the shielding effect for the foregoing a-Si films or p-Si films.

However, when Cr or the resin black is used as a material of the black matrix in the liquid crystal display panel, since the light reflectance thereof is low, the strong projected light is absorbed to result in a high temperature of the liquid crystal display panel itself, which is not desirable.

In view of this, a thin film made of high reflectance metal such as Al or Ag is generally used as the black matrix provided on the opposite substrate of the liquid crystal display panel.

However, the foregoing prior art has the following problems.

Specifically, if the high reflection film such as an Al thin film is used as the black matrix, a portion of the projected light entering liquid crystal cells becomes stray light that is reflected off the high reflection film to cause light contamination. As a result, the light enters TFTs to cause a malfunction of the liquid crystal display panel, so that the contrast of an image projected on a screen or the like is lowered.

On the other hand, if an Ag thin film, which has a higher reflectance than the Al thin film, is used as the black matrix, there has been a problem that the reflected light from the Ag thin film is tinged with yellow, and thus the color purity of an image projected on a screen or the like is lowered.

Further, if the Ag thin film is used as the black matrix, there has also been a problem that a fine pattern can not be formed.

In view of the above, JP 9-211439 A, for example, discloses that a layer of a member having a high reflectance (high reflection film) is first provided on a glass substrate forming an opposite substrate and then a layer of a member made of black resin or Cr oxide and having a low reflectance (low reflection film) is provided thereon, thereby to form a black matrix or a matrix-shaped film on the glass substrate.

With this structure, projected light entering from the side of the glass substrate where the black matrix is not formed is reflected off the high reflectance layer thereby to prevent the temperature of the liquid crystal display panel from increasing, on the other hand, stray light entering liquid crystal cells is absorbed by the low reflectance layer thereby to prevent a malfunction of the liquid crystal display panel.

However, since the low reflectance layer is formed on the high reflectance layer, there has been a problem that when strong light emitted from, for example, a projector lamp is entered, a stress is generated at an interface between the high reflectance layer and the low reflectance layer due to a difference in coefficient of thermal expansion between the member having the high reflectance and the member having the low reflectance, so that exfoliation is caused between the layers.

Further, there has been a problem that when the high reflectance layer is made of Al or a substance including Al as a main component, exfoliation is generated between the layers due to oxidation of Al.

Moreover, since the interface is formed between the high reflectance layer and the low reflectance layer in the two-layered structure, there has been a problem that two processes, i.e. a process of patterning the high reflectance layer and a process of patterning the low reflectance layer, are necessary in the fabrication processing of the black matrix, so that steps are generated in a pattern shape of the black matrix, resulting in poor dimensional accuracy of the black matrix.

On the other hand, there has also been a problem that pinholes are formed in the black matrix with a lapse of time in which the projected light is applied, and the projected light passing through the pinholes enters TFTs disposed on the confronting driving substrate, thereby to cause a malfunction of the liquid crystal display panel.

### SUMMARY OF THE INVENTION

Therefore, it is an object of the present invention to provide an opposite substrate for a liquid crystal display panel, wherein a portion made of a member having a high reflectance and a portion made of a member having a low reflectance that form a black matrix on the opposite substrate are not subjected to exfoliation due to a generated stress, and in addition, the black matrix has no steps in its pattern shape with excellent dimensional accuracy, and further provide a fabricating method thereof.

It is another object of the present invention to provide an opposite substrate for a liquid crystal display panel that is highly reliable, wherein the formation of a pinhole in a black matrix provided on the opposite substrate is suppressed to prevent a malfunction of the liquid crystal display panel.

For solving the foregoing problems, the present invention has one of the following structures.

(Structure 1)

An opposite substrate for use in a liquid crystal display panel including a driving substrate having a plurality of pixel electrodes and a plurality of switching elements for switching the plurality of pixel electrodes, respectively, the opposite substrate disposed so as to confront the driving substrate with a predetermined gap therefrom, and liquid crystals retained in the predetermined gap, the opposite substrate comprising a light-transmitting substrate and a light-shielding film, the light-shielding film formed on the light-transmitting substrate at least in one or both of regions corresponding to the switching elements and regions corresponding to driving circuits for driving the liquid crystal display panel, wherein the light-shielding film comprises a member having a high reflectance, on a side thereof facing the light-transmitting substrate, and a member having a low reflectance, on a side thereof facing the driving substrate, and wherein, between a portion constituted of the member having the high reflectance and a portion constituted of the member having the low reflectance, a portion is provided where the member having the high reflectance and the member having the low reflectance exist mixedly.

With this structure, a stress that is generated due to the fact that the member having the high reflectance and the member having the low reflectance are made of different materials, can be reduced by the portion where the member having the high reflectance and the member having the low reflectance exist mixedly, so that occurrence of exfoliation at an interface between the member having the high reflectance and the member having the low reflectance can be suppressed.

Further, when patterning the light-shielding film to form a black matrix, a difference in etching rate between the member having the high reflectance and the member having the low reflectance can be reduced by the portion where the member having the high reflectance and the member having the low reflectance exist mixedly. Thus, generation of rugged steps in a pattern edge portion can be suppressed, thereby to improve the dimensional accuracy.

As a result, the reliable opposite substrate for the liquid crystal display panel that is free of occurrence of a malfunction of the liquid crystal display panel can be achieved.

The light-shielding film is formed at least in one or both of regions corresponding to the switching elements and regions corresponding to driving circuits for driving the liquid crystal display panel. The driving substrate is formed thereon with a plurality of switching elements and gridiron-formed wiring (data lines, scanning lines, etc.) for connecting the plurality of switching elements to each other. The light-shielding film may be formed into a matrix shape so as to prevent light from entering the plurality of switching elements and the gridiron-formed wiring, or may be formed into stripes so as to prevent light from entering the plurality of switching elements and the wiring in one direction, or may be formed into islands that correspond to the plurality of switching elements, respectively. The light-shielding film may also be formed at regions corresponding to driving circuits for driving the liquid crystal display panel, in addition to the above or alone.

Here, the member having the high reflectance has such a reflectance that can suppress the increase in temperature of the liquid crystal display panel caused by absorption of light when the light enters the liquid crystal display panel, thereby to prevent a malfunction. On the other hand, the member having the low reflectance has such a reflectance that can prevent a malfunction caused by entering of stray light into switching elements, which is generated after the light enters the liquid crystal display panel.

(Structure 2)

The opposite substrate according to Structure 1, wherein, in the portion where the member having the high reflectance and the member having the low reflectance exist mixedly, a component of the member having the high reflectance decreases stepwise and/or continuously in a direction from the side of the light-transmitting substrate toward the side of the driving substrate, or a component of the member having the low reflectance increases stepwise and/or continuously in the direction, or a component of the member having the high reflectance decreases stepwise and/or continuously in the direction and a component of the member having the low reflectance increases stepwise and/or continuously in the direction.

With this structure, in the portion where the member having the high reflectance and the member having the low reflectance exist mixedly, the members change a mixedly existing ratio therebetween stepwise and/or continuously, so that the stress generated due to the fact that the member having the high reflectance and the member having the low reflectance are made of different materials, can be further reduced.

Moreover, when patterning the light-shielding film to form the black matrix, a difference in etching rate between the member having the high reflectance and the member having the low reflectance can be further reduced, so that a quite excellent pattern section with nearly no pattern steps can be obtained. Accordingly, the reliable opposite substrate for the liquid crystal display panel that is free of occurrence of a malfunction can be obtained, and further, the light-shielding film that has a desired composition inclination can be easily obtained by a later-described in-line type sputtering method, which provides high production merit.

(Structure 3)

The opposite substrate according to Structure 1 or 2, wherein the light-shielding film is a film in which a component of the member having the high reflectance and a component of the member having the low reflectance change in composition continuously.

With this structure, the stress generated by the member having the high reflectance and the member having the low reflectance can be further reduced as compared with even Structure 2.

Further, the pattern section characteristic upon patterning the light-shielding film to form the black matrix can be further improved as compared with even Structure 2.

Moreover, since the light-shielding film that has a desired composition inclination can be easily obtained by the later-described in-line type sputtering method, the production merit is also high.

(Structure 4)

The opposite substrate according to any one of Structures 1 to 3, wherein a main component of the member having the high reflectance is Al, while a main component of the member having the low reflectance is Cr and/or Ni.

By using Al as the main component of the member having the high reflectance, such a high reflection thin film can be obtained wherein the light reflectance is high in a wavelength region of 380 nm to 700 nm being a visible light wavelength region, and further, the wavelength dependency of the reflectance is low thereby to achieve the uniform reflectance.

In addition, when Cr and/or Ni is used as the main component of the member having the low reflectance, the adhesion to the member having the high reflectance with Al as the main component can be excellent, and the black matrix with a fine pattern can be formed.

As a result, the reliable opposite substrate for the liquid crystal display panel that is free of occurrence of a malfunction can be obtained.

Here, the optical density of the black matrix comprising the portion constituted of the member having the high reflectance, the portion constituted of the member having the low reflectance, and the portion where the member having the high reflectance and the member having the low reflectance exist mixedly, is 3 or greater, preferably 4 or greater.

(Structure 5)

The opposite substrate according to any one of Structures 1 to 4, wherein oxygen and/or nitrogen is contained in the member having the low reflectance, on a side thereof facing the driving substrate.

With this structure, the reflection preventing function of the member having the low reflectance can be further enhanced to suppress occurrence of a malfunction due to stray light. Further, since the film thickness can be reduced while maintaining a desired reflection preventing function, the patterning characteristic can also be improved.

As a result, the reliable opposite substrate for the liquid crystal display panel that is free of occurrence of a malfunction can be obtained.

(Structure 6)

The opposite substrate according to Structure 5, wherein, in the member having the low reflectance, the oxygen and/or nitrogen decreases continuously in a direction from the side of the driving substrate toward the side of the light-transmitting substrate.

With this structure, when patterning the light-shielding film to form the black matrix, there can be obtained such a black matrix that has no rugged steps at a pattern edge portion and that has an excellent patterning characteristic.

As a result, the reliable opposite substrate for the liquid crystal display panel that is free of occurrence of a malfunction can be obtained.

(Structure 7)

The opposite substrate according to any one of Structures 1 to 6, wherein a reflectance of the member having the high reflectance is 70% or greater, and a reflectance of the member having the low reflectance is 30% or less.

With this structure, of light that was about to enter the liquid crystal display panel from the side of the substrate, 70% or more of the light hitting upon the black matrix is reflected.

As a result, the increase in temperature of the liquid crystal display panel can be suppressed to prevent a malfunction.

Further, after entering the liquid crystal display panel, when the light having become the stray light hits upon the member having a reflectance lower than that of the member having the high reflectance, the reflectance becomes 30% or less.

As a result, a malfunction that is generated due to the fact that the stray light in the liquid crystal display panel enters TFTs (switching elements) can be prevented.

The foregoing reflectance represents a reflectance in a visible light wavelength range (380 to 700 nm) where the liquid crystal display panel is used.

(Structure 8)

The opposite substrate according to Structures 1 to 7, wherein a substrate formed with microlenses is provided on a side of the light-transmitting substrate from which light enters the opposite substrate, and wherein the microlenses are formed so as to project the light to the pixel electrodes, respectively.

With this structure, beam of incident light entering the opposite substrate for the liquid crystal display panel can be first narrowed upon passing through the microlenses, thereby to enable the light to pass through, for example, openings of the black matrix.

As a result, the reliable opposite substrate for the liquid crystal display panel that is free of occurrence of a malfunction can be obtained, and further, since the utilization efficiency of the incident light can be enhanced, a bright and excellent image can be obtained.

(Structure 9)

A liquid crystal display panel produced by using the opposite substrate according to any one of Structures 1 to 8.

With this structure, the reliable liquid crystal display panel that is free of occurrence of a malfunction can be obtained.

(Structure 10)

A method of fabricating an opposite substrate for use in a liquid crystal display panel including a driving substrate having a plurality of pixel electrodes and a plurality of switching elements for switching the plurality of pixel electrodes, respectively, the opposite substrate disposed so as to confront the driving substrate with a predetermined gap therefrom, and liquid crystals retained in the predetermined gap, wherein the opposite substrate comprises a light-transmitting substrate and a light-shielding film, the light-shielding film formed on the light-transmitting substrate at least in one or both of regions corresponding to the switching elements and regions corresponding to driving circuits for driving the liquid crystal display panel, and wherein the light-shielding film comprises a member having a high reflectance, on a side thereof facing the light-transmitting substrate, and a member having a low reflectance, on a side thereof facing the driving substrate, the method comprising: a light-shielding film forming step of forming the member having the high reflectance and the member having the low reflectance continuously on the light-transmitting substrate by sputtering, and further forming, between the member having the high reflectance and the member having the low reflectance, a portion in which sputtering particles for forming the member having the high reflectance and sputtering particles for forming the member having the low reflectance are formed into a film in a superposed fashion.

This structure makes it possible to generate a portion on the light-transmitting substrate such as a glass substrate, wherein sputtering particles for forming the member having the high reflectance and sputtering particles for forming the member having a reflectance lower than that of the member having the high reflectance are mutually superposed, and to perform the film formation continuously. Then, the formed light-shielding film has a composition of the member having the high reflectance near the glass substrate to exhibit a high reflectance, while decreases a composition ratio of the member having the high reflectance and increases a composition ratio of the member having a lower reflectance as approaching the film surface thereof confronting the driving substrate. Then, on the film surface confronting the driving substrate, there exists no composition of the member having the high reflectance, or there exists a small amount of the member having the high reflectance as compared with the member having the low reflectance. Thus, the reflectance of the film surface can be suppressed.

As a result, by changing the composition of the light-shielding film continuously, the reliable opposite substrate for the liquid crystal display panel that is free of exfoliation at an interface between the member having the high reflectance and the member having a lower reflectance and that is free of occurrence of a malfunction, can be easily fabricated.

(Structure 11)

The method according to Structure 10, further comprising: a step of forming a photosensitive resin film on the light-shielding film after the light-shielding film forming step; a step of patterning the photosensitive resin film by photolithography to form a photosensitive resin film pattern; and a light-shielding film pattern forming step of patterning the member having the low reflectance using the photosensitive resin film pattern as a mask, then removing the photosensitive resin film using an alkaline solvent and simultaneously etching the member having the high reflectance using the member having the low reflectance as a mask, thereby to form a matrix-shaped light-shielding film pattern.

With this structure, in the fabricating method of the opposite substrate for the liquid crystal display panel, after patterning the member having the low reflectance using the photosensitive resin film pattern as a mask, the photosensitive resin film (resist film) and the member having the high reflectance can be simultaneously removed by etching using an alkaline solvent.

As a result, the fabrication process can be reduced to lower the fabrication cost of the opposite substrate for the liquid crystal display panel.

In this event, materials of the member having the high reflectance, the member having the low reflectance and the photosensitive resin film (resist film) are not particularly limited. However, the resist film and the member having the high reflectance should be made of materials that can be etched by the alkaline solvent, and further, the material of the member having the high reflectance should have resistance to an etching liquid upon etching the member having the low reflectance, and also to the alkaline solvent.

(Structure 12)

The method according to Structure 11, wherein the member having the high reflectance is made of Al or an Al alloy, and the member having the low reflectance is made of Cr or a Cr alloy.

Structure 12 specifies typical materials of the member having the high reflectance and the member having the low reflectance.

When patterning the light-shielding film to form the black matrix according to the fabricating method of Structure 12, the thickness of the member having the high reflectance is preferably 100 to 800 Å, and the thickness of the member having the low reflectance is preferably 80 to 2000 Å.

(Structure 13)

A method of fabricating a liquid crystal display panel, wherein the liquid crystal display panel is fabricated using the opposite substrate obtained by the fabricating method according to Structure 12.

With this structure, the reliable liquid crystal display panel that is free of occurrence of a malfunction can be fabricated.

(Structure 14)

An opposite substrate for use in a liquid crystal display panel including a driving substrate having a plurality of pixel electrodes and a plurality of switching elements for switching the plurality of pixel electrodes, respectively, the opposite substrate disposed so as to confront the driving substrate with a predetermined gap therefrom, and liquid crystals retained in the predetermined gap, the opposite substrate comprising a light-transmitting substrate and a light-shielding film, the light-shielding film formed on the light-transmitting substrate at least in one or both of regions corresponding to the switching elements and regions corresponding to driving circuits for driving the liquid crystal display panel, wherein the light-shielding film comprises a metal thin film at least on a side thereof facing the light-transmitting substrate, and wherein the metal thin film contains an element for suppressing generation of migration.

With this structure, the generation or progress of migration in the metal thin film caused by a film stress, thermal load or the like applied to the light-shielding film can be suppressed.

This structure is based on a result of analysis conducted by the present inventors that the formation of a pinhole in the light-shielding film is caused by migration generated and advanced in the metal thin film forming the light-shielding film on the light-incident side thereof. Accordingly, by suppressing the generation or progress of the migration in the metal thin film, the formation of the pinhole can be prevented.

As a result of this structure, since the generation or progress of the migration can be suppressed even when the opposite substrate for the liquid crystal display panel is subjected to the intense projected light, a pinhole is not formed in the light-shielding film so that a malfunction of the liquid crystal display panel can be prevented.

The light-shielding film is formed at least in one or both of regions corresponding to the switching elements and regions corresponding to driving circuits for driving the liquid crystal display panel. The driving substrate is formed thereon with a plurality of switching elements and gridiron-formed wiring (data lines, scanning lines, etc.) for connecting the plurality of switching elements to each other. The light-shielding film may be formed into a matrix shape so as to prevent light from entering the plurality of switching elements and the gridiron-formed wiring, or may be formed into stripes so as to prevent light from entering the plurality of switching elements and the wiring in one direction, or may be formed into islands that correspond to the plurality of switching elements, respectively. The light-shielding film may also be formed at regions corresponding to driving circuits for driving the liquid crystal display panel, in addition to the above or alone.

(Structure 15)

The opposite substrate according to Structure 14, wherein the element for suppressing the generation of the migration is at least one selected from the group consisting of Ti, Cu and Si.

Among elements having an effect for suppressing the generation of migration, Ti, Cu or Si can be easily added to the metal thin film forming the light-shielding film. Further, the metal thin film added with at least one element selected from Ti, Cu and Si fully bears mechanical and optical characteristics as a light-shielding film.

As a result, without lowering the optical characteristic and productivity of the opposite substrate for the liquid crystal display panel, the element for suppressing the generation of migration can be added to the metal thin film forming the light-shielding film.

(Structure 16)

The opposite substrate according to Structure 14 or 15, wherein the content of the element in the metal thin film falls within a range of 0.1 to 5 at %.

With this structure, when the metal thin film forming the light-shielding film is, for example, etched into a matrix shape, the etching characteristic is prevented from lowering, while, when it is subjected to the projected light, the generation or progress of the migration can be suppressed.

As a result, the element for suppressing the generation of the migration can be added without lowering the productivity of the opposite substrate for the liquid crystal display panel.

(Structure 17)

The opposite substrate according to any one of Structures 14 to 16, wherein the metal thin film is a high reflection film having a high reflectance for suppressing a malfunction of the liquid crystal display panel, the malfunction caused by absorption by the light-shielding film of incident light entering the opposite substrate.

In order to suppress occurrence of a malfunction of the liquid crystal display panel caused by absorption of the incident light by the light-shielding film formed in the opposite substrate, the reflectance of the high reflection film made of the metal thin film formed on the side closer to the light-transmitting substrate is preferably at least 70% or greater, more preferably 80% or greater, and further preferably 90% or greater in the visible light wavelength range.

(Structure 18)

The opposite substrate according to claim 17, wherein the high reflection film contains an Al alloy and/or an Ag alloy.

When a thin film made of Al or an Al alloy, or Ag or an Ag alloy is used as the high reflection film, and an element for suppressing the generation of the migration is added thereto, the metal thin film can be obtained wherein the light reflectance is high in the wavelength region of 380 nm to 700 nm being the visible light wavelength region, and further, the wavelength dependency of the reflectance is low and the uniform reflectance can be achieved, and further, even when subjected to the projected light, the generation or progress of the migration can be suppressed.

As a result, the opposite substrate for the liquid crystal display panel having an excellent characteristic can be easily fabricated.

(Structure 19)

The opposite substrate according to Structure 17 or 18, wherein the light-shielding film comprises a low reflection film on a side thereof facing the driving substrate, the low reflection film having a reflectance lower than that of the high reflection film.

When the intense projected light passes through the liquid crystal display panel, stray light is generated. If this stray light is applied to TFTs or the like on the driving substrate, a malfunction of the liquid crystal display panel is induced.

By adopting this structure, the reflection of the stray light by the light-shielding film toward the TFTs or the like on the driving substrate to cause a malfunction of the liquid crystal display panel can be prevented, and further, lowering of the contrast of a projected image can also be prevented.

The reflection of the stray light in the liquid crystal cells can be reduced as the reflectance decreases. Accordingly, the reflectance of the low reflection film is preferably 30% or less, more preferably 20% or less, and further preferably 10% or less.

(Structure 20)

The opposite substrate according to claim 19, wherein the low reflection film is made of one of Ti, Cr, W, Ta, Mo, Pb, an oxide of each of the elements, a nitride of each of the elements, an oxide-nitride of each of the elements, an oxide of a high melting point metal silicide of each of the elements, a nitride of a high melting point metal silicide of each of the elements, and an oxide-nitride of a high melting point metal silicide of each of the elements.

Since the reflection of the stray light in the liquid crystal cells can be reduced as the reflectance decreases, the low reflection film is preferably made of one of Ti, Cr, W, Ta, Mo, Pb, an oxide of each of such elements, a nitride of each of such elements, an oxide-nitride of each of such elements, an oxide of a high melting point metal silicide of each of such elements, a nitride of a high melting point metal silicide of each of such elements, an oxide-nitride of a high melting point metal silicide of each of such elements, and organic black coloring matter.

In addition, since the low reflection film can be easily formed on the opposite substrate by sputtering, vapor deposition or the like after the formation of the high reflection film being the metal thin film, the opposite substrate for the liquid crystal display panel having an excellent characteristic can be easily fabricated.

If the low reflection film is made of Cr, Cr oxide, Cr nitride or Cr oxide-nitride, and the metal thin film is made of an AlTi alloy, thereby to form the light-shielding film having those films, the adhesion is strong between the films, and the pattern section characteristic becomes sharp upon etching the light-shielding film.

(Structure 21)

The opposite substrate according to any one of Structures 17 to 20, wherein the high reflection film and the low reflection film form a continuous film whose composition changes continuously.

With this structure, when placed in an environment where the temperature largely changes from ordinary temperature to high temperature, and from high temperature to ordinary temperature, a stress caused by physical property such as a difference in thermal expansion coefficient between the high reflection film being the metal thin film and the low reflection film can be reduced.

Further, since the high temperature film and the low temperature film form a continuous film whose composition changes continuously, the shape stability is excellent upon etching the light-shielding film into a matrix shape.

Moreover, it is possible to adopt such a method wherein, upon forming the high reflection film and the low reflection film continuously by sputtering, the sputtering is performed by generating a portion where sputtering particles of a high reflection film material and sputtering particles of a low reflection film material are mutually superposed.

According to this method, the high reflection film and the low reflection film can be changed in composition stepwise or continuously and at a desired rate in a cross-section direction or a film thickness direction of the light-shielding film. Thus, the interface between the high reflection film and the low reflection film is not subjected to exfoliation, so that the light-shielding film with excellent durability can be formed, and in addition, the matrix-shaped light-shielding film with a fine pattern can be formed.

(Structure 22)

The opposite substrate according to any one of Structures 14 to 21, wherein, with respect to the light-transmitting substrate, a substrate formed with microlenses is provided on the side from which light enters the opposite substrate, and the microlenses are formed such that the light is projected to the pixel electrodes.

With this structure, beam of the incident light entering the opposite substrate for the liquid crystal display panel is narrowed upon passing through microlenses provided, for example, correspondingly to openings of the matrix-shaped light-shielding film. As a result, most of the incident light passes through the openings of the matrix-shaped light-shielding film and further passes through the driving substrate without entering TFTs (switching elements) formed on the driving substrate.

Therefore, the thermal load applied to the matrix-shaped light-shielding film formed in the opposite substrate and the TFTs formed on the driving substrate, due to the incident light and the stray light is reduced. Accordingly, there can be obtained the reliable opposite substrate for the liquid crystal display panel that is free of occurrence of malfunction, and further, the utilization efficiency of the projected light can be enhanced.

As a result, combined with the effect of the element added to the light-shielding film for suppressing the migration, the liquid crystal display panel having this structure is highly reliable and can project a bright excellent image.

### BRIEF DESCRIPTION OF THE DRAWINGS

FIG. 1 is a sectional view of an opposite substrate according to a first embodiment of the present invention;

FIG. 2 is a sectional view of an opposite substrate with a microlens substrate according to a modification of the first embodiment of the present invention;

FIG. 3 is a sectional view of an opposite substrate with a microlens substrate according to another modification of the first embodiment of the present invention;

FIG. 4 is a diagram showing a result of analyzing a black matrix of the opposite substrate according to the first embodiment of the present invention, based on the Auger analyzing method;

FIG. 5 is a sectional view of an opposite substrate according to a second embodiment of the present invention;

FIG. 6 is a table showing an evaluation result with respect to the pinhole occurrence number and the matrix-shaped light-shielding film pattern shape;

FIG. 7 is a diagram for explaining a method of evaluating a pattern shape of a matrix-shaped light-shielding film;

FIG. 8 is a sectional view of an opposite substrate with a light-shielding film having only a high reflection film, according to a modification of the second embodiment of the present invention; and

FIG. 9 is a sectional view of an opposite substrate with a microlens substrate according to another modification of the second embodiment of the present invention.

### DESCRIPTION OF THE PREFERRED EMBODIMENT

Now, preferred embodiments of the present invention will be described hereinbelow with reference to the accompanying drawings.

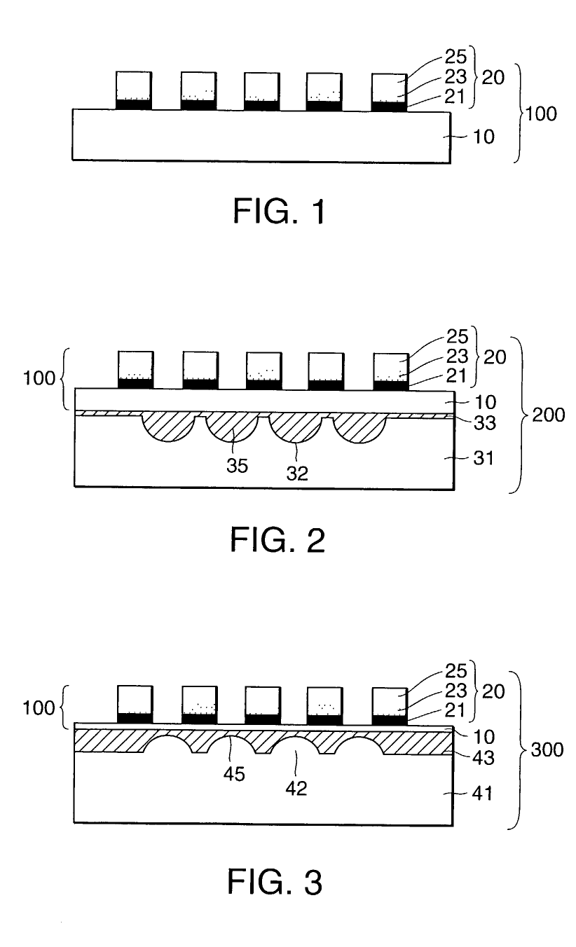

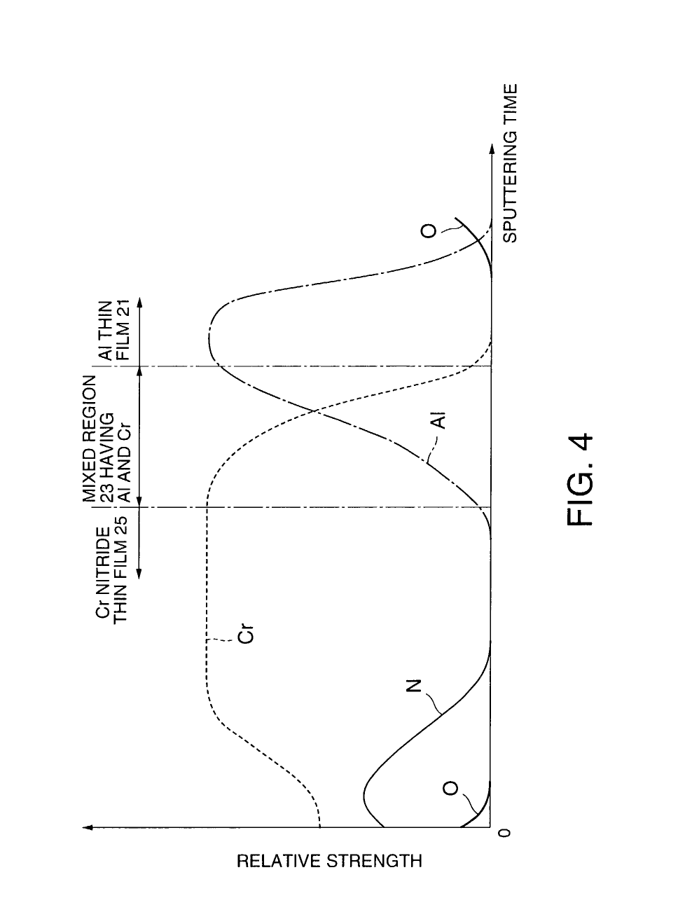

FIG. 1 is an exemplary sectional view of an opposite substrate according to a first embodiment of the present invention. FIGS. 2 and 3 are exemplary sectional views of opposite substrates each with a microlens substrate according to modifications of the first embodiment of the present invention. FIG. 4 is a diagram showing a result of analyzing a black matrix of the opposite substrate according to the first embodiment of the present invention, based on the Auger analyzing method. Through FIGS. 1 to 4, corresponding portions are assigned the same reference numerals.

(Opposite Substrate)

First, the opposite substrate shown in FIG. 1 will be described.

The opposite substrate 100 comprises a glass substrate 10 and a black matrix 20. The black matrix 20 comprises a member having a high reflectance (hereinafter referred to as “high reflection film 21”), a member having a reflectance lower than that of the high reflection film 21 (hereinafter referred to as “low reflection film 25”), and a region 23 where components of the high reflection film 21 and components of the low reflection film 25 exist mixedly. Normally, the opposite substrate further comprises a transparent conductive film covering the black matrix. Hereinbelow, no explanation will be given of the transparent conductive film.

On the transparent glass substrate 10 as a light-transmitting substrate, the black matrix 20 is formed in a matrix shape at regions corresponding to switching elements disposed on a driving substrate (not shown) and wiring connecting the switching elements together. Preferably, a transparent quartz substrate, a no-alkali glass substrate or the like is used for the glass substrate 10. The high reflection film 21 is formed on the side of the black matrix 20 facing the glass substrate 10, while the low reflection film 25 is formed on the side of the black matrix 20 facing the driving substrate (not shown). Between the high reflection film 21 and the low reflection film 25 is provided the region 23 where the components of the high reflection film and the components of the low reflection film are mixedly present. Specifically, the region 23 is formed such that the high reflection film components and the low reflection film components change in composition stepwise and/or continuously. In this event, the optical density of the black matrix 20 comprising the high reflection film 21, the region 23 and the low reflection film 25 is at least 3 or greater, preferably 4 or greater.

Hereinbelow, explanation will be given of the high reflection film 21, the low reflection film 25, the region 23 where the high reflection film components and the low reflection film components exist mixedly, preferred examples of forming those films, the formation of the black matrix, and the opposite substrates each having a microlens substrate.

(High Reflection Film)

The reflectance of the high reflection film 21 is preferably 70% or greater, more preferably 80% or greater, and further preferably 90% or greater in a visible light wavelength range (380 to 700 nm). The reason is that the increase in temperature of the panel gets smaller as the reflection increases.

The high reflection film 21 is preferably made of metal such as Ni, Ag, Pt or Al, or an Al or Ag alloy containing a small amount of addition metal such as Pd.

Particularly, by using Al or the Al alloy for the high reflection film 21, the light reflectance can be high in a wavelength region of 380 nm to 700 nm being a visible light wavelength region, and further, the wavelength dependency of the reflectance can be low and the uniform reflectance can be achieved. Moreover, the adhesion to the later-described low reflection film 25 can be excellent and the black matrix 20 with a fine pattern can be formed.

Preferably, the thickness of the high reflection film 21 is no less than 100 Å and no greater than 800 Å. If the thickness is less than 100 Å, it is difficult to obtain the high reflectance of 70% or greater, and the reflectance largely varies depending on the forming condition upon fabrication, which is not desirable. On the other hand, if the thickness exceeds 800 Å, it is possible that exfoliation between the high reflection film 21 and the low reflection film 25 occurs.

(Low Reflection Film)

The reflectance of the low reflection film 25 is preferably 30% or less, more preferably 20% or less, and further preferably 10% or less. The reason is that the reflection of stray light in the liquid crystal cells can be reduced as the reflectance decreases.

The low reflection film 25 is preferably made of metal such as Cr, Ni, Si or Ge, metal oxide thereof, metal nitride thereof, metal oxide-nitride thereof, high melting point metal silicide of Ti, Cr, W, Ta, Mo, Pd or the like, oxide, nitride or oxide-nitride of, for example, WSi (tungsten silicide) or MoSi (molybdenum silicide), carbon or organic black coloring matter. Preferably, after the formation of the high reflection film 21 on the glass substrate 10, the low reflection film 25 is formed on the high reflection film 21 as a uniform thin film by sputtering or vapor deposition.

Particularly, by using Cr, Ni, metal oxide thereof, i.e. chromium oxide or nickel oxide, or metal oxide-nitride thereof such as chromium oxide-nitride or nickel oxide-nitride for the low reflection film 25, the adhesion to the high reflection film 21 can be excellent, and the black matrix 20 with a fine pattern can be formed. Further, by increasing the degree of oxidation and/or the degree of nitriding of metal oxide, metal nitride or metal oxide-nitride contained in the low reflection film 25 in a direction from the side of the high reflection film 21 toward the side of the driving substrate stepwise and/or continuously, the optical characteristics can be improved without lowering the foregoing adhesion.

In case of using a thin film of the foregoing metal oxide, metal nitride or metal oxide-nitride as the low reflection film 25, it is desirable to adopt a method wherein, upon the formation of a film of such a metal compound, oxygen and/or nitrogen is introduced into the film so as to form a metal oxide, metal nitride or metal oxide-nitride having a desired composition, a method wherein, after the formation of a film of metal, the film is heated under oxygen and/or nitrogen so as to form a desired metal oxide, metal nitride or metal oxide-nitride, or a method wherein, using a target material of metal oxide, metal nitride or metal oxide-nitride, a thin film of a desired metal oxide, metal nitride or metal oxide-nitride is formed by sputtering.

Further, if a thin film of the foregoing metal, metal oxide thereof, metal nitride thereof or metal oxide-nitride thereof is used as the low reflection film 25, the shielding performance thereof is high even with a small thickness, and the reflectance can be lowered. In addition, since alkali metal that hinders driving of the liquid crystal display panel is not contained, it is optimum as a light-shielding film for the liquid crystal display panel.

Preferably, the thickness of the low reflection film 25 is no less than 80 Å and no greater than 2000 Å. If the thickness is less than 80 Å, it is difficult to obtain the low reflectance of 30% or lower. On the other hand, if the thickness exceeds 2000 Å, the reflectance is held constant, and further, it is possible that exfoliation between the low reflection film 25 and the high reflection film 21 occurs.

On the other hand, in case of using the foregoing high melting point metal silicide for the low reflection film 25, it is also desirable to adopt a method wherein, using a target material of a high melting point metal silicide compound, a thin film of a desired high melting point metal silicide is formed by sputtering, or a method wherein, after forming a high melting point metal film and an Si film by vapor deposition or sputtering, the films are heated to be formed into a high melting point metal silicide compound thin film.

(Region Where Components of High Reflection Film and Components of Low Reflection Film Exist Mixedly)

Between the high reflection film 21 and the low reflection film 25, the region 23 is formed where the components of both reflection films are mixedly present. It is desirable that, in the region 23, the components of the high reflection film 21 decrease stepwise and/or continuously in the direction from the side of the glass substrate 10 toward the side of the driving substrate (not shown), or the components of the low reflection film 25 increases stepwise and/or continuously in such a direction, or the components of the high reflection film 21 decreases stepwise and/or continuously in such a direction and the components of the low reflection film 25 increases stepwise and/or continuously in such a direction.

In any one of the structures, when the black matrix 20 is subjected to the incident light, a stress that is generated an interface between the high reflection film 21 and the low reflection film 25 can be reduced.

Further, when forming the black matrix 20 by etching a light-shielding film having the high reflection film 21 and the low reflection film 25, since there is no definite interface between the high reflection film 21 and the low reflection film 25, generation of steps in a rugged fashion caused by a difference in etching rate therebetween can be suppressed.

It may also be arranged that the region 23 where the components of both reflection films 21 and 25 are mixedly present occupies all the regions of the light-shielding film except its lower and upper ends, in FIG. 1, facing the glass substrate 10 and the driving substrate, respectively.

Further, in case of using the metal oxide, metal nitride or metal oxidenitride used for the low reflection film 25, the adhesion between the high reflection film 21 and the low reflection film 25 can be largely improved by providing the region 23.

(Film Forming Method of High Reflection Film, Low Reflection Film, and Region Where Components of High Reflection Film and Components of Low Reflection Film Exist Mixedly)

(Film Forming Method 1)

As a film forming method for arranging the composition in the region 23, where the components of the high reflection film 21 and the low reflection film 25 are mixedly present, so as to change stepwise and/or continuously, the following film forming method can be adopted wherein, after forming the high reflection film 21 and the low reflection film 25, the films 21 and 25 are subjected to a heat treatment so that the substance forming the high reflection film 21 and the substance forming the low reflection film 25 are mutually subjected to thermal diffusion at the interface between the films, thereby to realize a stepwise and/or continuous composition change to form the region 23 where the components of the high reflection film 21 and the low reflection film 25 are mixedly present.

(Film Forming Method 2)

Alternatively, the following film forming method can be adopted wherein, after forming the high reflection film 21 and the low reflection film 25 using substances that are mutually reactive to form a compound, the films 21 and 25 are subjected to a heat treatment or the like to cause a reaction at the interface between the films 21 and 25, thereby to realize a stepwise and/or continuous composition change to form the region 23 where the components of the high reflection film 21 and the low reflection film 25 are mixedly present.

For example, the low reflection film 25 is made of Si or an Si compound, while the high reflection film 21 is made of a substance such as W, Ni, Cr or Al that is reactive with Si, and then both films are subjected to heating.

(Film Forming Method 3)

Further, there is another film forming method wherein, upon successively forming the high reflection film 21 and the low reflection film 25 on the glass substrate 10 by sputtering, sputtering particles forming the high reflection film 21 and sputtering particles forming the low reflection film 25 are sputtered on the glass substrate 10 by mutually superposing those sputtering particles.

According to this film forming method, a constituent substance of the high reflection film 21 and a constituent substance of the low reflection film 25 can be changed in composition stepwise and/or continuously and at a desired rate in a cross-section direction or a film thickness direction of the black matrix 20. Thus, the interface between the high reflection film 21 and the low reflection film 25 is not subjected to exfoliation, so that the light-shielding film with excellent durability can be formed, and in addition, the black matrix 20 with a fine pattern can be formed.

In this case, as a film forming method for mutually superposing the sputtering particles forming the high reflection film 21 and the sputtering particles forming the low reflection film 25, it is desirable to adopt, for example, a method wherein a target material forming the high reflection film 21 and a target material forming the low reflection film 25 are placed adjacently to each other, or a method wherein the target materials and the substrate are sufficiently distanced from each other to cause overlapping of the sputtering particles on the substrate.

Particularly, such a method wherein the target material forming the high reflection film 21 and the target material forming the low reflection film 25 are juxtaposed in one target material, is quite excellent because the high reflection film 21 and the low reflection film 25 can be formed by such one target material and, by controlling widths of the target material forming the high reflection film 21 and the target material forming the low reflection film 25, the thicknesses of the high reflection film 21 and the low reflection film 25 can also be controlled.

(Formation of Black Matrix)

According to the foregoing film forming methods and so on, an Al or Al alloy thin film being the high reflection film 21 is formed on the glass substrate 10 by sputtering or vapor deposition, then the region 23, where Al and Cr of Cr or a Cr alloy being a component of the low reflection film 25 change in composition stepwise and/or continuously and exist mixedly, is formed on the Al or Al alloy thin film, and further, a Cr or Cr alloy thin film being the low reflection film 25 is formed on the region 23, thereby to obtain a light-shielding film.

The obtained light-shielding film is subjected to photolithography and etching using photosensitive resin as a resist film thereby to pattern the low reflection film 25, then the photosensitive resin is removed by an alkaline aqueous solution and simultaneously the Al or Al alloy thin film being the high reflection film 21 is etched by the alkaline aqueous solution, thereby to form the black matrix 20. According to the fabrication method described in (Structure 11), in the step of etching the Al or Al alloy thin film being the high reflection film 21, the etching is advanced using the low reflection film 25 as an etching mask, so that the edge shape of the black matrix 20 can be formed sharp.

Further, the etching of the Al or Al alloy thin film being the high reflection film 21 and the removal of the patterned photosensitive resin can be simultaneously carried out. Thus, it is an excellent method with many advantages.

(Opposite Substrate with Microlens Substrate)

Referring now to FIGS. 2 and 3, opposite substrates each with a microlens substrate will be described.

First, an opposite substrate 200 with a microlens substrate shown in FIG. 2 will be described.

The opposite substrate 200 comprises a glass substrate 10, a black matrix 20, a glass substrate 31 having concave portions 32 whose bottom walls form curved surfaces, respectively, and a high refraction medium 33. The black matrix 20 comprises a high reflection film 21, a low reflection film 25 and a region 23 where components of the high reflection film 21 and components of the low reflection film 25 exist mixedly. The glass substrate 10 and the glass substrate 31 having the concave portions 32 whose bottom walls each form a curved surface, sandwich the high refraction medium 33 therebetween so as to form a microlens array having many microlenses 35 each serving as a convex lens.

Specifically, the opposite substrate 200 has a structure such that the high refraction medium 33 is interposed between the foregoing opposite substrate 100 and the glass substrate 31, thereby to form the microlenses 35 that function as convex lenses.

In this case, the concave portions 32 are formed such that the apex of the concave portion 32 of each microlens 35 and the center of a corresponding opening of the black matrix 20 coincide with each other.

By providing the microlens substrate as described above, when entering the opposite substrate of the liquid crystal display panel, beam of incident light is narrowed upon passing through the microlenses 35 after having passed through the glass substrate 31. As a result, most of the incident light passes through openings of the black matrix 20 and further passes through a driving substrate without entering TFTs (switching elements) disposed on the driving substrate.

Consequently, the thermal load applied to the black matrix 20 due to the incident light is reduced, and the stray light entering the TFTs (switching elements) formed on the driving substrate is decreased. Accordingly, there can be obtained the reliable opposite substrate for the liquid crystal display panel that can suppress occurrence of malfunction, and further, since the utilization efficiency of light can be increased, a bright and excellent image can be obtained.

Now, an opposite substrate 300 with a microlens substrate shown in FIG. 3 will be described.

The opposite substrate 300 comprises a glass substrate 10, a black matrix 20, a glass substrate 41 having convex portions 42 whose top walls form curved surfaces, respectively, and a low refraction medium 43. The black matrix 20 comprises a high reflection film 21, a low reflection film 25 and a region 23 where components of the high reflection film 21 and components of the low reflection film 25 exist mixedly. The glass substrate 10 and the glass substrate 41 having the convex portions 42 whose top walls each form a curved surface, sandwich the low refraction medium 43 therebetween so as to form a microlens array having many microlenses 45 each serving as a convex lens.

Specifically, the opposite substrate 300 has a structure such that the low refraction medium 43 is interposed between the foregoing opposite substrate 100 and the glass substrate 41, thereby to form the microlenses 45 that function as convex lenses.

In this case, the convex portions 42 are formed such that a focus of each microlens 45 is located at the center of a corresponding opening of the black matrix 20.

Then, like in case of the foregoing opposite substrate 200, beam of incident light is narrowed upon passing through the microlenses 45, so that most of the incident light passes through openings of the black matrix 20 and the inside of the liquid crystal display panel, and further passes through a driving substrate without entering TFTs (switching elements) disposed on the driving substrate.

Consequently, the thermal load applied to the black matrix 20 due to the incident light is reduced, and the stray light entering the TFTs (switching elements) formed on the driving substrate is decreased. Accordingly, there can be obtained the reliable opposite substrate for the liquid crystal display panel that can suppress occurrence of malfunction, and further, since the utilization efficiency of light can be increased, a bright and excellent image can be obtained.

Now, using examples, the present invention will be described in further detail.

### EXAMPLE 1

A 6-inch target material according to an in-line sputtering apparatus specification, wherein an Al target material with Al in a 2-inch width at a substrate carry-in side and a Cr target material with Cr in a 4-inch width at a substrate carry-out side were placed adjacently to each other at an interval of one inch therebetween, was disposed in an in-line sputtering apparatus.

Using this in-line sputtering apparatus, an Al thin film having a thickness of 200 Å and a Cr nitride thin film having a thickness of 800 Å were formed on a no-alkali glass substrate (NA35: produced by NH Techno Glass Corporation) 10 having a thickness of 1.1 mm, wherein the formation of the Cr nitride thin film was carried out while flowing argon gas containing nitrogen from the substrate carry-out side during sputtering. In this event, there was formed between the Al thin film and the Cr nitride thin film a mixed region having Al and Cr, wherein Al decreases continuously in a direction from the surface of the no-alkali glass substrate toward the side of a driving substrate, while Cr increases continuously in such a direction.

Photosensitive resin (resist) having a thickness of 5000 Å was applied onto the Cr nitride thin film by the spin-coating method, then, using a photomask, a resist film in a matrix shape with a width of 4 μm and a pitch of 26 μm was formed.

The substrate formed with this matrix-shaped resist film was immersed in a Cr etching liquid (HY liquid produced by Wako Pure Chemical Industries, Ltd.) to etch the Cr nitride thin film, then immersed in an alkaline aqueous solution being a removal liquid for the photosensitive resin to remove the photosensitive resin and simultaneously etch the Al thin film, thereby to obtain a black matrix, so that an opposite substrate for a liquid crystal display panel was obtained.

FIG. 4 shows a result of analyzing the obtained black matrix of the opposite substrate for the liquid crystal display panel, based on the Auger analyzing method.

The axis of ordinates represents relative strengths of signals from elements existing in the black matrix. The axis of abscissas represents an analyzing position in the black matrix, wherein the left side represents a surface of the black matrix facing the driving substrate, while the right side represents a surface thereof contacting the no-alkali glass substrate.

As clear from FIG. 4, the Al thin film being the high reflection film 21 is formed on the no-alkali glass substrate, the mixed region 23, where Al and Cr being a component of the low reflection film 25 change in composition continuously and exist mixedly, is formed on the Al thin film, and further, the Cr nitride thin film being the low reflection film 25 is formed on the mixed region 23, and there is no interface existing between the Al thin film and the Cr nitride thin film.

The obtained opposite substrate for the liquid crystal display panel exhibited a reflectance of 91% from the side of the glass surface, i.e. the surface of the opposite substrate at the light-incident side (reflectance of the glass substrate surface at the light-incident side+reflectance of the Al thin film surface at the light-incident side), and a reflectance of 8% from the side of the driving substrate (i.e. reflectance of the Cr nitride thin film surface).

100 samples of such an opposite substrate were prepared, and a cellophane adhesive tape peeling test described below was carried out to evaluate film adhesion of black matrixes of the samples.

First, the samples were subjected to 1000 cycles of a high-temperature low-temperature environmental test between 120° C. (30 minutes) and −55° C. (30 minutes).

Thereafter, the peeling test using cellophane adhesive tape was conducted with respect to the black matrixes of the opposite substrates of the samples.

The result was that no exfoliation occurred between the high reflection film and the low reflection film (0/100 samples).

The peeling test using cellophane adhesive tape is a test wherein adhesive tape prescribed in JISZ1522 and having a width of 12 to 19 mm is stuck onto the black matrix of the opposite substrate, then the adhesive tape is strongly pulled in a direction perpendicular to the film surface of the black matrix so as to tear off the adhesive tape instantaneously, thereby to evaluate the state of the black matrix in this event.

Further, upon observing a pattern section of the black matrix using an electron microscope, it was confirmed that the high reflection film and the low reflection film changed in composition gradually and continuously so that no steps were recognized in the respective layers and a sharp pattern was obtained. As a result, a pattern edge portion observed from the side of the driving substrate was very smooth and the dimensional accuracy of the formed black matrix was also excellent.

A liquid crystal display panel was produced using the foregoing obtained opposite substrate, and projected light was applied thereto. It was confirmed that no malfunction occurred.

### EXAMPLE 2

On a quartz glass substrate having a thickness of 1.1 mm, an Ag thin film containing 1 at % of Pd and having a thickness of 800 Å was formed by vapor deposition, thereby to obtain a high reflection film. Then, an Ni thin film having a thickness of 1200 Å was formed on the Ag thin film by sputtering, thereby to obtain a low reflection film.

Then, the quartz glass substrate formed with the Ag thin film and the Ni thin film was heated at 600° C. for an hour in an oxygen-nitrogen atmosphere containing 5 vol % of oxygen, thereby to form a mixed region having Ag and Ni at an interface between the Ag thin film and the Ni thin film due to thermal diffusion, wherein Ag decreases continuously in a direction from the surface of the no-alkali glass substrate toward the side of the driving substrate, while Ni increases continuously in such a direction.

In this event, the surface of the Ni thin film was subjected to oxidation-nitriding due to oxygen and nitrogen in the heated atmosphere, so that Ni oxide-nitride was formed.

Photosensitive resin (resist) having a thickness of 5000 Å was applied onto the Ni oxide-nitride thin film by the spin-coating method, then, using a photomask, a resist film in a matrix shape with a width of 4 μm and a pitch of 26 μm was formed.

The substrate formed with this matrix-shaped resist film was immersed in a ferric chloride solution to etch the Ni oxide-nitride thin film, then the Ag thin film was removed by dry etching under Ar gas. Then, the resist film was dissolved and removed in an alkaline aqueous solution, thereby to obtain a black matrix, so that an opposite substrate for a liquid crystal display panel was obtained.

The obtained opposite substrate for the liquid crystal display panel exhibited a reflectance of 86% from the side of the glass surface, i.e. the surface of the opposite substrate at the light-incident side (reflectance of the glass substrate surface at the light-incident side+reflectance of the Ag thin film surface at the light-incident side), and a reflectance of 27% from the side of the driving substrate (i.e. reflectance of the Ni oxide-nitride thin film surface).

Like in Example 1, 100 samples of such an opposite substrate were prepared, and a cellophane adhesive tape peeling test was carried out to evaluate film adhesion of black matrixes of the samples.

The result was that no exfoliation occurred between the high reflection film and the low reflection film (0/100 samples).

Further, like in Example 1, upon observing a pattern section of the black matrix using an electron microscope, it was confirmed that the high reflection film and the low reflection film changed in composition gradually and continuously so that no steps were recognized in the respective layers and a sharp pattern was obtained. As a result, a pattern edge portion observed from the side of the driving substrate was very smooth and the dimensional accuracy of the formed black matrix was also excellent.

A liquid crystal display panel was produced using the foregoing obtained opposite substrate, and projected light was applied thereto. It was confirmed that no malfunction occurred.

### EXAMPLE 3

On a quartz glass substrate having a thickness of 1.1 mm, an Al thin film having a thickness of 300 Å was formed by vapor deposition, thereby to obtain a high reflection film. Then, an Si thin film having a thickness of 100 Å was formed by sputtering, and a Cr thin film having a thickness of 800 Å was formed on the Si thin film by sputtering, thereby to obtain a low reflection film.

Then, the substrate formed with the Al thin film, the Si thin film and the Cr thin film was heated at 600° C. for an hour in an Ar gas atmosphere containing 0.1 vol % of nitrogen monoxide, thereby to form between the Al thin film and the Cr thin film a region that has a layer of a compound of Al and Si and a layer of a compound of Si and Cr. In this event, the surface of the Cr thin film was subjected to oxidation-nitriding due to nitrogen monoxide in the heated atmosphere, so that Cr oxide-nitride was formed.

Photosensitive resin (resist) having a thickness of 5000 Å was applied onto the Cr oxide-nitride thin film by the spin-coating method, then, using a photomask, a resist film in a matrix shape with a width of 4 μm and a pitch of 26 μm was formed.

Then, the substrate formed with this matrix-shaped resist film was immersed in a ferric chloride solution and then in a mixed solution of phosphoric acid and nitric acid to etch the Cr oxide-nitride thin film, the region having the Al—Si compound layer and the Si—Cr compound layer, and the Al thin film, and finally the resist film was dissolved and removed in an alkaline aqueous solution, thereby to obtain a black matrix, so that an opposite substrate for a liquid crystal display panel was obtained.

The obtained opposite substrate for the liquid crystal display panel exhibited a reflectance of 82% from the side of the glass surface, i.e. the surface of the opposite substrate at the light-incident side (reflectance of the glass substrate surface at the light-incident side+reflectance of the Al thin film surface at the light-incident side), and a reflectance of 12% from the side of the driving substrate (i.e. reflectance of the Cr oxide-nitride thin film surface).

Like in Example 1, 100 samples of such an opposite substrate were prepared, and a cellophane adhesive tape peeling test was carried out to evaluate film adhesion of black matrixes of the samples.

The result was that no exfoliation occurred between the high reflection film and the low reflection film (0/100 samples).

Further, like in Example 1, upon observing a pattern section of the black matrix using an electron microscope, it was confirmed that the high reflection film and the low reflection film changed in composition gradually and continuously so that no steps were recognized in the respective layers and a sharp pattern was obtained. As a result, a pattern edge portion observed from the side of the driving substrate was very smooth and the dimensional accuracy of the formed black matrix was also excellent.

A liquid crystal display panel was produced using the foregoing obtained opposite substrate, and projected light was applied thereto. It was confirmed that no malfunction occurred.

### EXAMPLE 4

A 6-inch target material according to an in-line sputtering apparatus specification, wherein an Al target material with Al in a 2-inch width at a substrate carry-in side and a Cr oxide target material with Cr oxide in a 4-inch width at a substrate carry-out side were placed adjacently to each other at an interval of one inch therebetween, was disposed in an in-line sputtering apparatus.

Using this in-line sputtering apparatus, an Al thin film having a thickness of 100 Å and a Cr oxide thin film having a thickness of 800 Å were formed on a no-alkali glass substrate (NA35: produced by NH Techno Glass Corporation) having a thickness of 1.1 mm. In this event, there was formed between the Al thin film and the Cr oxide thin film a mixed region having Al and Cr, wherein Al decreases continuously in a direction from the surface of the no-alkali glass substrate toward the side of a driving substrate, while Cr increases continuously in such a direction.

Photosensitive resin (resist) having a thickness of 5000 Å was applied onto the Cr oxide thin film by the spin-coating method, then, using a photomask, a resist film in a matrix shape with a width of 4 μm and a pitch of 26 μm was formed.

The substrate formed with this matrix-shaped resist film was immersed in a Cr etching liquid (HY liquid produced by Wako Pure Chemical Industries, Ltd.) and then in a mixed solution of phosphoric acid and nitric acid to etch the Cr oxide thin film, the mixed region having Al and Cr, and the Al thin film, and finally the resist film was dissolved and removed in an alkaline aqueous solution, thereby to obtain a black matrix, so that an opposite substrate for a liquid crystal display panel was obtained.

The obtained opposite substrate for the liquid crystal display panel exhibited a reflectance of 87% from the side of the glass surface, i.e. the surface of the opposite substrate at the light-incident side (reflectance of the glass substrate surface at the light-incident side+reflectance of the Al thin film surface at the light-incident side), and a reflectance of 16% from the side of the driving substrate (i.e. reflectance of the Cr oxide thin film surface).

Like in Example 1, 100 samples of such an opposite substrate were prepared, and a cellophane adhesive tape peeling test was carried out to evaluate film adhesion of black matrixes of the samples.

The result was that no exfoliation occurred between the high reflection film and the low reflection film (0/100 samples).

Further, like in Example 1, upon observing a pattern section of the black matrix using an electron microscope, it was confirmed that the high reflection film and the low reflection film changed in composition gradually and continuously so that no steps were recognized in the respective layers and a sharp pattern was obtained. As a result, a pattern edge portion observed from the side of the driving substrate was very smooth and the dimensional accuracy of the formed black matrix was also excellent.

A liquid crystal display panel was produced using the foregoing obtained opposite substrate, and projected light was applied thereto. It was confirmed that no malfunction occurred.

### EXAMPLE 5

Four kinds of target materials were disposed in an in-line sputtering apparatus. Specifically, from a substrate carry-in side toward a substrate carry-out side of the in-line sputtering apparatus, an Al target material as a first target, an Al—Cr mixture target material (Al:70 at %, Cr:30 at %) as a second target, a Cr—Al mixture target material (Cr:70 at %, Al:30 at %) as a third target, and a Cr target material as a fourth target were disposed in the order named.

Using this in-line sputtering apparatus, on a no-alkali glass substrate (NA35: produced by NH Techno Glass Corporation) having a thickness of 1.1 mm, an Al thin film having a thickness of 100 Å was formed using the first target, an Al—Cr thin film containing an Al—Cr mixture (Al content>Cr content) and having a thickness of 200 Å was formed using the second target, a Cr—Al thin film containing a Cr—Al mixture (Cr content>Al content) and having a thickness of 300 Å was formed using the third target, and a Cr oxide thin film having a thickness of 400 Å was formed using the fourth target.

In this event, the sputtering based on the first to third targets was carried out in an Ar gas atmosphere, and the sputtering based on the fourth target was carried out in an Ar gas atmosphere containing oxygen.

Accordingly, a mixed region having Al and Cr was formed wherein Al decreases stepwise in a direction from the surface of the no-alkali glass substrate toward the side of a driving substrate, while Cr increases stepwise in such a direction.

Photosensitive resin (resist) having a thickness of 5000 Å was applied onto the formed thin film by the spin-coating method, then, using a photomask, a resist film in a matrix shape with a width of 4 μm and a pitch of 26 μm was formed.

The substrate formed with this matrix-shaped resist film was immersed in a Cr etching liquid (HY liquid produced by Wako Pure Chemical Industries, Ltd.) and then in a mixed solution of phosphoric acid and nitric acid to etch the Cr oxide thin film, the mixed region having Al and Cr, and the Al thin film, and finally the resist film was dissolved and removed in an alkaline aqueous solution, thereby to obtain a black matrix, so that an opposite substrate for a liquid crystal display panel was obtained.

The obtained opposite substrate for the liquid crystal display panel exhibited a reflectance of 88% from the side of the glass surface, i.e. the surface of the opposite substrate at the light-incident side (reflectance of the glass substrate surface at the light-incident side+reflectance of the Al thin film surface at the light-incident side), and a reflectance of 16% from the side of the driving substrate (i.e. reflectance of the Cr oxide thin film surface).

Like in Example 1, 100 samples of such an opposite substrate were prepared, and a cellophane adhesive tape peeling test was carried out to evaluate film adhesion of black matrixes of the samples.

The result was that there were two samples in which exfoliation occurred between the high reflection film and the low reflection film (2/100 samples), meaning that there is no practical problem.

Further, like in Example 1, upon observing a pattern section of the black matrix using an electron microscope, it was confirmed that the high reflection film and the low reflection film changed in composition gradually and stepwise so that small steps were recognized in the respective layers but a sharp pattern was obtained in terms of the whole black matrix. As a result, although a pattern edge portion observed from the side of the driving substrate included small steps, the dimensional accuracy of the formed black matrix was good enough not to raise any practical problem.

A liquid crystal display panel was produced using the foregoing obtained opposite substrate, and projected light was applied thereto. It was confirmed that no malfunction occurred.

### EXAMPLE 6

High refraction resin was applied to a glass substrate that was formed, by isotropic etching, with many concave portions whose bottom walls formed curved surfaces, respectively, and a cover glass substrate was adhered thereto via the high refraction resin to form a microlens array, thereby to prepare a microlens substrate. On the cover glass substrate of the microlens substrate, a black matrix was formed according to the same method as that in Example 1, thereby to prepare an opposite substrate with a microlens substrate for a liquid crystal display panel.

The obtained opposite substrate with the microlens substrate for the liquid crystal display panel exhibited a reflectance of 91% from the side of the glass surface, i.e. the surface of the opposite substrate at the light-incident side (reflectance of the glass substrate surface at the light-incident side+reflectance of the Al thin film surface at the light-incident side), and a reflectance of 8% from the side of the driving substrate (i.e. reflectance of the Cr nitride thin film surface).

Like in Example 1, 100 samples of such an opposite substrate were prepared, and a cellophane adhesive tape peeling test was carried out to evaluate film adhesion of black matrixes of the samples.

The result was that no exfoliation occurred between the high reflection film and the low reflection film (0/100 samples).

Further, like in Example 1, upon observing a pattern section of the black matrix using an electron microscope, it was confirmed that the high reflection film and the low reflection film changed in composition gradually and continuously so that no steps were recognized in the respective layers and a sharp pattern was obtained. As a result, a pattern edge portion observed from the side of the driving substrate was very smooth and the dimensional accuracy of the formed black matrix was also excellent.

A liquid crystal display panel was produced using the foregoing obtained opposite substrate, and projected light was applied thereto. It was confirmed that no malfunction occurred.

### Comparative Example 1

Using an in-line sputtering apparatus, an Al thin film having a thickness of 300 Å was formed on a no-alkali glass substrate (NA35: produced by NH Techno Glass Corporation) having a thickness of 1.1 mm in an Al thin film forming chamber, then the substrate was taken out from the Al thin film forming chamber, and a Cr thin film having a thickness of 800 Å was formed on the Al thin film in a Cr thin film forming chamber.

Photosensitive resin having a thickness of 5000 Å was applied onto the Cr thin film by the spin-coating method, then, using a photomask, a resist film in a matrix shape with a width of 4 μm and a pitch of 26 μm was formed.

The substrate formed with this matrix-shaped resist film was immersed in a Cr etching liquid (HY liquid produced by Wako Pure Chemical Industries, Ltd.) to etch the Cr thin film, and then immersed in a mixed solution of phosphoric acid and nitric acid to etch the Al thin film, and finally the photosensitive resin was dissolved and removed in an alkaline aqueous solution, thereby to obtain a black matrix, so that an opposite substrate for a liquid crystal display panel was obtained.

The obtained opposite substrate for the liquid crystal display panel exhibited a reflectance of 87% from the side of the glass surface, i.e. the surface of the opposite substrate at the light-incident side (reflectance of the glass substrate surface at the light-incident side+reflectance of the Al thin film surface at the light-incident side), and a reflectance of 60% from the side of the driving substrate (i.e. reflectance of the Cr thin film surface).

Like in Example 1, 100 samples of such an opposite substrate were prepared, and a cellophane adhesive tape peeling test was carried out to evaluate film adhesion of black matrixes of the samples.

The result was that there were 15 samples in which exfoliation occurred between the high reflection film and the low reflection film (15/100 samples).

Further, like in Example 1, upon observing a pattern section of the black matrix using an electron microscope, large steps were recognized at an interface between the high reflection film and the low reflection film, and a pattern edge portion observed from the side of the driving substrate was formed in a rugged fashion.

A liquid crystal display panel was produced using the foregoing obtained opposite substrate, and projected light was applied thereto. It was confirmed that the high reflection film and the low reflection film of the opposite substrate were subjected to exfoliation to cause a malfunction of the liquid crystal display panel.

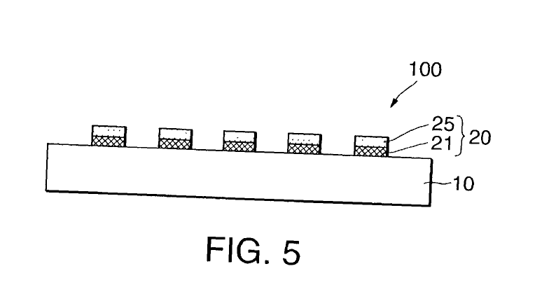

FIG. 5 is an exemplary sectional view of an opposite substrate according to a second embodiment of the present invention.

In FIG. 5, the opposite substrate 400 comprises a light-transmitting substrate 50 and a light-shielding film 60. The opposite substrate 400 may further comprise a transparent conductive film covering the light-shielding film 60. The light-shielding film 60 comprises a metal thin film 61 (hereinafter referred to as “high reflection film 61”) on the side thereof facing the light-transmitting substrate 50, and a thin film 65 of a member having a reflectance lower than that of the high reflection film 61 (hereinafter referred to as “low reflection film 65”), on the side thereof confronting a driving substrate (not shown).

The light-shielding film 60 is formed in a matrix shape on the light-transmitting substrate 50 at regions confronting switching elements for individually switching pixel electrodes on the non-shown driving substrate and wiring connecting the switching elements to each other.

The light-transmitting substrate 50 is required to be made of a transparent material that can withstand a thermal action of intense projected light. For example, a transparent quartz substrate, a no-alkali glass substrate or the like is preferably used as the light-transmitting substrate 50.

The high reflection film 61 forming the light-shielding film 60 is preferably made of metal such as Ni, Ag, Pt or Al, or an Al or Ag alloy containing a small amount of addition metal such as Pd, and added with an element that suppresses the generation or progress of migration.

Particularly, when a material containing Al is used as a main component of the high reflection film 61, the light reflectance can be high in a wavelength region of 380 nm to 700 nm being a visible light wavelength region, and further, the wavelength dependency of the reflectance can be low and the uniform reflectance can be achieved. Moreover, the adhesion to the later-described low reflection film 65 can be excellent and the matrix-shaped light-shielding film 60 with a fine pattern can be formed.

The low reflection film 65 forming the light-shielding film 60 is preferably made of metal, metal oxide, metal nitride, metal oxide-nitride, high melting point metal silicide of Ti, Cr, W, Ta, Mo, Pd or the like, oxide, nitride or oxide-nitride of, for example, WSi (tungsten silicide) or MoSi (molybdenum silicide), organic black coloring matter, or the like.

As described above, in order to suppress occurrence of a pinhole in the matrix-shaped light-shielding film 60 when the opposite substrate 400 is subjected to the projected light, the element for suppressing the generation or progress of the migration is added to the high reflection film 61. Preferably, this element is one selected from Ti, Cu, Si, Pd and so on.

In case of using a material containing Al as a main component for a material of the high reflection film 61 of the light-shielding film 60 and using a material containing Cr as a main component for a material of the low reflection film 65, it is desirable to select Ti as an element for suppressing the generation or progress of the migration because interface exfoliation does not occur between the high reflection film 61 and the low reflection film 65 upon patterning the light-shielding film 60 to form the matrix-shaped light-shielding film.

Therefore, taking the opposite substrate 400 as an example wherein Ti is selected as an addition element for suppressing the generation of the migration, the high reflection film 61 contains Al as a main component, the low reflection film 65 contains Cr as a main component, and the light-shielding film 60 is formed into a matrix shape, an effect of adding the addition element for suppressing the generation of the migration will be described.

As described above, the film containing Al as the main component that is used for the high reflection film 61 is a desirable metal film in that the light reflectance can be high in the wavelength region of 380 nm to 700 nm being the visible light wavelength region, and further, the wavelength dependency of the reflectance can be low and the uniform reflectance can be achieved, and further that the adhesion to the later-described low reflection film 65 can be excellent and the matrix-shaped light-shielding film with a fine pattern can be formed.

As the low reflection film 65, an Cr nitride film is used. The reflectance of the low reflection film is preferably 30% or less, more preferably 20% or less, and further preferably 10% or less. The reason is that the reflection of stray light in the liquid crystal cells can be reduced as the reflectance decreases. The Cr nitride film is desirable in that it has a desirable optical characteristic as a low reflection film, and simultaneously, when it is formed on the foregoing Al film, the strong film adhesion is exhibited therebetween, and further, it is excellent in shape stability upon forming the light-shielding film into a matrix shape, which will be describe later.

As a method of adding Ti into the Al film, the following method is desirable in view of operation efficiency and cost, wherein, when forming a film containing Al as a main component onto the light-transmitting substrate by sputtering, a given amount of Ti is added into a sputtering target of Al or an Al alloy in advance.

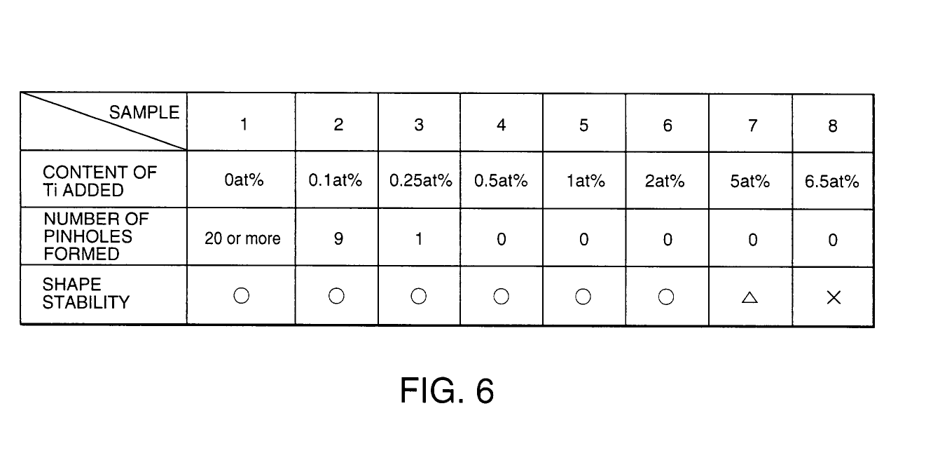

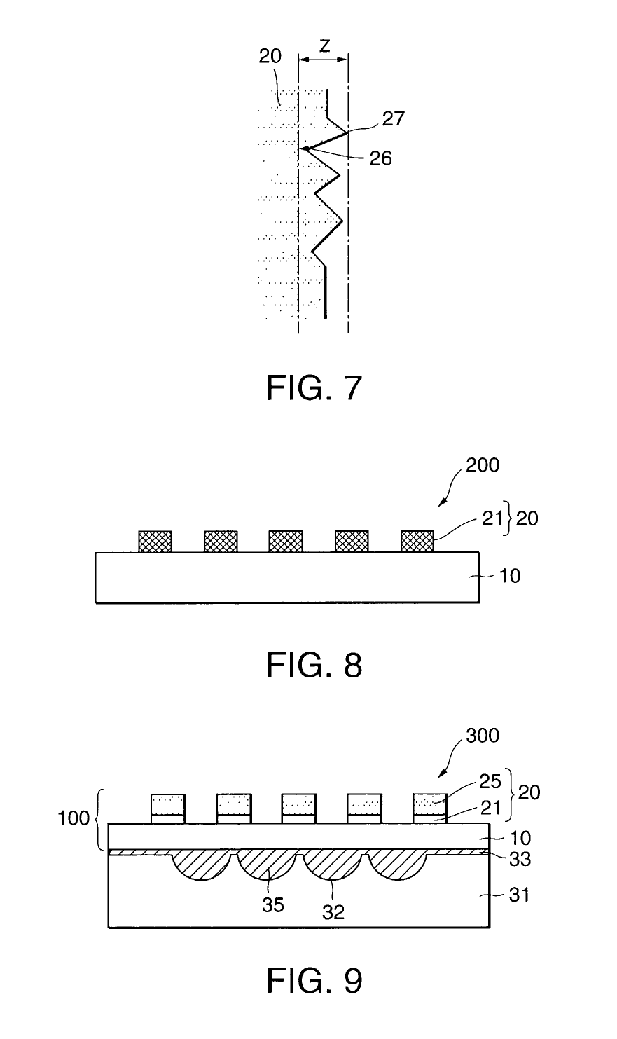

Now, referring to FIGS. 6 and 7, an effect obtained by adding Ti into the light-shielding film 60 as an addition element for suppressing the generation or progress of the migration will be described.

FIG. 6 is a table showing an evaluation result with respect to the adding amount of Ti added as an element for suppressing the generation or progress of the migration into metal thin films being high reflection films forming light-shielding film samples (1 to 8) on light-transmitting substrates in opposite substrates, the pinhole occurrence rates in the light-shielding film samples (1 to 8), and the shape stability upon light-shielding film etching in the light-shielding film samples (1 to 8).

FIG. 7 is a sectional view exemplarily showing an etched shape of a light-shielding film, upon evaluating the shape stability after etching the foregoing light-shielding film samples.

Hereinbelow, the pinhole occurrence suppression effect achieved by adding an element for suppressing the generation or progress of the migration into a metal thin film being a high reflection film, and the shape stability upon etching a light-shielding film will be described.

First, as substrates, no-alkali glass substrates (NA35: produced by NH Techno Glass Corporation) each having a thickness of 1.1 mm were prepared.

Then, a sputtering target for light-shielding film formation was prepared, wherein Al targets added with Ti in different concentrations and a Cr target were placed adjacently to each other at an interval of one inch therebetween.

As shown in FIG. 6, adding amounts of Ti relative to the Al targets are classified in eight levels within a range of 0 to 6.5 at %, which correspond to the samples 1 to 8, respectively.

Using an in-line sputtering apparatus, AlTi thin films with different Ti contents each having a thickness of 100 to 800 Å, preferably 200 to 400 Å, were formed on the glass substrates, then Cr nitride thin films each having a thickness of 80 to 2000 Å, preferably 300 to 1400 Å, were formed on the AlTi thin films, thereby to prepare the samples 1 to 8.

Sputtering was carried out while flowing an Ar gas containing nitrogen from a substrate carry-out side of the in-line sputtering apparatus.

Photosensitive resin (resist) having a predetermined thickness (e.g. 5000 Å) was applied onto each of the samples 1 to 8 after the film formation by the spin-coating method, then, using a photomask, a resist film in a matrix shape with a width of 4 μm and a pitch of 26 μm was formed.

Each of the samples 1 to 8 formed with this matrix-shaped resist film was immersed in a Cr etching liquid (HY liquid produced by Wako Pure Chemical Industries, Ltd.) to etch the Cr nitride thin film, then immersed in an alkaline aqueous solution to dissolve and remove the resist film and simultaneously etch the AlTi alloy thin film, thereby to obtain a matrix-shaped light-shielding film, so that the samples 1 to 8 for a liquid crystal display panel were obtained.

Then, with respect to the shape stability of the matrix-shaped light-shielding films formed in the opposite substrate samples 1 to 8, the evaluation was performed using an electron microscope.

A method of this evaluation will be described with reference to FIG. 7.

FIG. 7 is an exemplary diagram upon observing the matrix-shaped light-shielding film after etching, from an upper side of the formed light-shielding film using the electron microscope, wherein concave portions 66 and convex portions 67 generated on a boundary of the matrix-shaped light-shielding film pattern due to etching were observed. It is assumed that an interval between the deepest bottom of the concave portions 66 and the highest top of the convex portions 27 is set as Z.

Then, as the interval Z increases, the shape stability of the matrix-shaped light-shielding film is evaluated to be lower, which will cause a malfunction of a liquid crystal display panel in later processing.

This ruggedness on the surface is called roughness. The degree of roughness was evaluated according to the magnitude of the interval Z between the bottom of the concave portion and the top of the convex portion, and the shape stability upon etching the light-shielding film to obtain a black matrix was evaluated according to the degree of roughness.

In the evaluation, x was given to the case where the roughness Z exceeded 1 μm, Δ was given to the case where the roughness Z was 0.1 to 1 μm, and o was given to the case where the roughness Z was less than 0.1 μm. The evaluation result is shown in FIG. 6.

Subsequently, the opposite substrate samples 1 to 8 were placed in a convection oven and subjected to heating at 120° C. for 500 hours, then the presence/absence of pinhole occurrence in the matrix-shaped light-shielding films was observed using a metallurgical microscope.

After this heating test, when pinholes occurred in the opposite substrate samples 1 to 8, the number thereof was counted and entered in FIG. 6.

The number of pinhole occurrences was counted by observing a 5 mm×5 mm region on the surface of the high reflection film formed in each of the opposite substrate samples 1 to 8 using the metallurgical microscope.

As clear from the result shown in FIG. 6, in the evaluation based on the shape stability upon etching, it was found out that the samples 1 to 6 had essentially no roughness in the obtained patterns and thus had quite excellent pattern shapes. On the other hand, it was found out that the roughness of around 0.5 μm occurred in the sample 7, and the roughness exceeding 1 μm occurred in the sample 8 so that the pattern shape was quite bad.

From the foregoing, in order to form a light-shielding film having excellent pattern shape and pattern accuracy, the content of Ti in an AlTi alloy thin film is preferably 5 at % or less.

On the other hand, also clear from the result shown in FIG. 6, in the evaluation of the pinhole occurrence number, it was found out that the pinhole occurrence number was 20 or more in the sample 1, which represented the level to induce a malfunction due to light contamination if a liquid crystal display panel was fabricated using this sample.

It was found out that the pinhole occurrence number was 9 in the sample 2, which represented the level where there was a possibility to induce a malfunction due to light contamination if a liquid crystal display panel was fabricated using this sample.

It was found out that the pinhole occurrence number was 0 to 1 in the samples 3 to 8, which represented the level to induce no malfunction due to light contamination if a liquid crystal display panel was fabricated using any one of these samples.

From the foregoing, in order not to cause a malfunction due to light contamination, the content of Ti in an Al thin film is preferably 0.1 at % or more.

From the foregoing result, it was found out that the content of Ti in an Al film was preferably 0.1 to 5.0 at %, and more preferably 0.25 to 2.0 at %.

Further, using, instead of Ti, Si (1 at %), Cu (0.5 at %), and Si(0.5 at %)+Ti(0.5 at %) as an addition element for suppressing the generation or progress of the migration, and forming high reflection films using an AlSi alloy, an AlCu alloy, and an AlSiTi alloy, the evaluation was performed with respect to the pinhole occurrence number and the shape stability similarly to the foregoing evaluation. The result is that, in case of the AlSi alloy (Si: 1 at %) and the AlSiTi alloy (Si: 0.5 at %, Ti: 0.5 at %), the pinhole occurrence number was 0, while, in case of the AlCu alloy, the pinhole occurrence number was 2. On the other hand, in the shape stability, in case of the AlSiTi alloy (Si: 0.5 at %, Ti: 0.5 at %) and the AlCu alloy (Cu: 0.5 at %), the roughness Z was less than 0.1 μm, representing the excellent shape stability, while, in case of the AlSi alloy (Si: 1 at %), the roughness Z was a little larger, i.e. in a range of 0.1 to 1 μm.

From the result, the AlSi alloy, the AlCu alloy and the AlSiTi alloy may also be applicable instead of the AlTi alloy, and among them, the AlTi alloy is most desirable, and then the AlSiTi alloy follows.

Now, the low reflection film that is formed on the high reflection film added with the element for suppressing the migration, and preferred forming methods thereof will be described.

As described above, the low reflection film is preferably made of metal, metal oxide, metal nitride, metal oxide-nitride, high melting point metal silicide of Ti, Cr, W, Ta, Mo, Pd or the like, oxide, nitride or oxide-nitride of, for example, WSi (tungsten silicide) or MoSi (molybdenum silicide), or organic black coloring matter.

When using metal, metal oxide, metal nitride, metal oxide-nitride, high melting point metal silicide, or organic black coloring matter for the low reflection film, it is desirable to form a uniform thin film on the high reflection film by sputtering or vapor deposition, after the formation of the high reflection film on the light-transmitting substrate.

Further, in case of using a thin film of metal oxide, metal nitride or metal oxide-nitride as the low reflection film, it is desirable to adopt a method wherein, upon the formation of a film of such a metal compound, oxygen and/or nitrogen is introduced into the film so as to form a metal oxide, metal nitride or metal oxide-nitride having a desired composition, a method wherein, after the formation of a film of metal, the film is heated under oxygen and/or nitrogen so as to form a desired metal oxide, metal nitride or metal oxide-nitride, or a method wherein, using a target material of metal oxide, metal nitride or metal oxide-nitride, a thin film of a desired metal oxide, metal nitride or metal oxide-nitride is formed by sputtering.

On the other hand, in case of using high melting point metal silicide for the low reflection film, it is also desirable to adopt a method wherein, using a target material of a high melting point metal silicide compound, a thin film of a desired high melting point metal silicide is formed by sputtering, or a method wherein, after forming a high melting point metal film and an Si film by vapor deposition or sputtering, the films are heated to be formed into a high melting point metal silicide compound thin film.

Particularly, if a thin film of metal, metal oxide, metal nitride or metal oxide-nitride is used as the low reflection film, the shielding performance thereof is high even with a small thickness, and the reflectance can be lowered. In addition, since alkali metal that hinders driving of the liquid crystal display panel is not contained, it is optimum as a light-shielding film for the liquid crystal display panel.

Further, the thin film of metal oxide, metal nitride or metal oxide-nitride used as the low reflection film is further improved in adhesion as a low reflection film if it is formed such that a composition of the metal film changes continuously on the high reflection film.

Particularly, if Cr or Ni is used as metal, chromium oxide or nickel oxide is used as metal oxide, chromium nitride or nickel nitride is used as metal nitride, or chromium oxide-nitride or nickel oxide-nitride is used as metal oxide-nitride, the adhesion to the high reflection film added with the element for suppressing the migration can be excellent, and the matrix-shaped light-shielding film with a fine pattern can be formed.

When the thickness of the high reflection film added with the element for suppressing the migration is 300 Å or greater, the sufficient reflectance against the projected light is exhibited. When the thickness of the low reflection film is 80 Å or greater, the effect of capturing the stray light in the liquid crystal cells is exhibited. If the total thickness of the high reflection film and the low reflection film is 2000 Å or less, disconnection of pixel electrodes formed on the light-shielding film can be prevented and a thermal stress applied to the light-shielding film can be prevented from extremely increasing, which is thus a desirable structure.

In this event, the optical density of the light-shielding film comprising the high reflection film and the low reflection film is at least 3 or greater, preferably 4 or greater.

Depending on selection of materials of the high reflection film and the low reflection film, there may be raised a problem that exfoliation occurs at an interface between the high reflection film and the low reflection film.

Particularly, when the high reflection film is made of a substance containing Al as a main component, it is possible that exfoliation occurs due to oxidation of Al.

In this case, it is possible to form, between the high reflection film and the low reflection film, a portion where a member having a high reflectance that forms the high reflection film, and a member having a low reflectance that forms the low reflection film, exist mixedly. As a method of forming such a light-shielding film, the following film forming method can be adopted wherein, after forming the high reflection film and the low reflection film, the films are subjected to a heat treatment so that the substance forming the high reflection film and the substance forming the low reflection film are mutually subjected to thermal diffusion at the interface between the films, thereby to realize a stepwise or continuous composition change.

Alternatively, the foregoing light-shielding film can be obtained by forming the high reflection film and the low reflection film using substances that are mutually reactive to form a compound, and then subjecting both films to a heat treatment or the like to cause a reaction at the interface between the films. For example, the low reflection film is made of Si or an Si compound, while the high reflection film is made of a substance such as W, Ni, Cr or Al that is reactive with Si.

According to this method, when the light-shielding film is placed in a high temperature environment and an ordinary temperature environment, a stress caused by physical property such as a difference in thermal expansion coefficient between the high reflection film and the low reflection film can be reduced.

Further, there is another film forming method wherein, upon successively forming the high reflection film and the low reflection film on the light-transmitting substrate by sputtering, sputtering particles forming the high reflection film and sputtering particles forming the low reflection film are sputtered such that a portion where those sputtering particles are mutually superposed is generated on the light-transmitting substrate. According to this film forming method, a constituent substance of the high reflection film and a constituent substance of the low reflection film can be changed in composition stepwise or continuously and at a desired rate in a cross-section direction or a film thickness direction of the light-shielding film. Thus, the interface between the high reflection film and the low reflection film is not subjected to exfoliation, so that the light-shielding film with excellent durability can be formed, and in addition, the matrix-shaped light-shielding film with a fine pattern can be formed.

In this case, as a film forming method for generating the portion where the sputtering particles made of the constituent substance of the high reflection film and the sputtering particles made of the constituent substance of the low reflection film are mutually superposed on the light-transmitting substrate, it is desirable to adopt, for example, a method wherein a target material forming the high reflection film and a target material forming the low reflection film are placed adjacently to each other, or a method wherein the target materials and the substrate are sufficiently distanced from each other to generate a portion where the sputtering particles are mutually superposed on the substrate.

Particularly, such a method wherein the target material forming the high reflection film and the target material forming the low reflection film are juxtaposed in one target material, is quite excellent because the high reflection film and the low reflection film can be formed by such one target material and, by controlling widths of the target material forming the high reflection film and the target material forming the low reflection film, the thicknesses of the high reflection film and the low reflection film can also be controlled.

As described above, as the high reflection film, a metal thin film is used which is made of metal such as Al, Ni, Ag or Pt, or an alloy of such metal added with a small amount of addition metal such as Pd, and added with an element for suppressing the migration. Therefore, if the low reflection film is made of chromium oxide or nickel oxide as metal oxide of Cr or Ni, or chromium nitride or nickel nitride as metal nitride of Cr or Ni, the matrix-shaped light-shielding film with a fine pattern, that is excellent in adhesion with the foregoing high reflection film, can be formed. In the oxide or nitride of the low reflection film, it is desirable that the degree of oxidation or the degree of nitriding increases stepwise in a direction from the side of the high reflection film toward the side of the driving substrate.

There is also another structure wherein an Al or Al alloy thin film added with an element for suppressing the migration, being the high reflection film, is formed on the light-transmitting substrate by sputtering or vapor deposition, then a region, where Al and a component of the low reflection film change in composition stepwise and/or continuously and exist mixedly, is formed on the Al or Al alloy thin film, and further, the low reflection film is formed on such a region, thereby to obtain a light-shielding film.

The obtained light-shielding film is subjected to photolithography and etching using photosensitive resin as a resist film thereby to pattern the low reflection film, then the photosensitive resin is removed by an alkaline aqueous solution and simultaneously the Al or Al alloy thin film being the high reflection film is etched by the alkaline aqueous solution, thereby to form the matrix-shaped film.

According to this method of fabricating the matrix-shaped light-shielding film, in the process of etching the Al or Al alloy thin film being the high reflection film, the etching is advanced using the low reflection film as an etching mask, so that the edge shape of the matrix-shaped light-shielding film can be formed sharp.

Further, the etching of the Al or Al alloy thin film being the high reflection film and the removal of the patterned photosensitive resin can be simultaneously carried out. Thus, it is an excellent method with many advantages.

FIG. 8 is an exemplary sectional view of an opposite substrate with a light-shielding film having only a high reflection film, according to a modification of the second embodiment of the present invention. FIG. 9 is an exemplary sectional view of an opposite substrate with a microlens substrate according to another modification of the second embodiment of the present invention.

In FIGS. 5, 8 and 9, corresponding portions are assigned the same reference numerals.

Referring to FIG. 8, the opposite substrate 500 comprises a light-transmitting substrate 50 and a light-shielding film 60. The opposite substrate 500 may further comprise a transparent conductive film covering the light-shielding film 60. The light-shielding film 60 comprises a high reflection film 61 and is formed into a matrix shape on the light-transmitting substrate 50.

As described above, in order to suppress the increase in temperature of a liquid crystal display panel when the intense projected light enters the liquid crystal display panel, the reflectance of the light-shielding film 60 is preferably 70% or greater, more preferably 80% or greater, and further preferably 90% or greater in the visible light wavelength range. In general, a thin film of Al or an Al alloy, or a thin film of Ag or an Ag alloy is preferably used as the high reflection film 61.

Further, the high reflection film 61 is added with an element that serves to suppress the generation or progress of the migration.

As the light-transmitting substrate 50, a transparent quartz substrate, a no-alkali glass substrate or the like is preferably used.

The opposite substrate 500 thus structured is preferably used in a liquid crystal display panel having a structure where a possibility of occurrence of stray light in liquid crystal cells is low, or TFTs or the like on a driving substrate are not easily influenced by stray light.

Referring to FIG. 9, the opposite substrate 600 with a microlens substrate comprises a light-transmitting substrate 50, a light-shielding film 60, a light-transmitting substrate 71 and a high refraction medium 73. The opposite substrate 600 may further comprise a transparent conductive film covering the light-shielding film 60. The light-shielding film 60 comprises a high reflection film 61 and a low reflection film 65. On the surface of the light-transmitting substrate 71 contacting the light-transmitting substrate 50, many concave portions 72 are formed in a matrix form, and the bottom wall of each concave portion 72 forms a curved surface. The concave portions 72 and the high refraction medium 73 form microlenses 75 that constitute a microlens array.

In the opposite substrate 600, the light-transmitting substrate 50, the light-shielding film 60, the high reflection film 61 and the low reflection film 65 have the same structures as those of the foregoing opposite substrate 400.

The high refraction medium 73 is interposed between the light-transmitting substrate 50 and the light-transmitting substrate 71 formed with the concave portions 72, and the concave portions 72 and the high refraction medium 73 constitute the microlenses 75 each having a function of a convex lens. Positions and the number of the microlenses 75 and the curved surface of the bottom wall of each concave portion 72 are adjusted such that the focus of each microlens 75 is located at the center of a corresponding opening of the matrix-shaped light-shielding film 60.

By using the opposite substrate 600 with the microlens substrate, incident light entering the opposite substrate 600 first passes through the light-transmitting substrate 71, then beam of the incident light is narrowed upon passing through the microlenses 75. As a result, most of the incident light passes through openings of the matrix-shaped light-shielding film 60, then passes through the driving substrate without being applied to TFTs formed on the driving substrate.

Consequently, the thermal load applied to the light-shielding film 60 and the TFTs formed on the driving substrate due to the incident light and the stray light is reduced. Accordingly, combined with the effect of the element added to the light-shielding film 60 for suppressing the migration, there can be obtained the reliable opposite substrate for the liquid crystal display panel that is free of occurrence of malfunction, and further, since the utilization efficiency of light can be enhanced, a bright and excellent image can be obtained.

Now, using examples, the present invention will be described in further detail.

### EXAMPLE 7

<AlTi Only>

An AlTi alloy thin film containing 0.5 at % of Ti with a thickness of 500Å was formed on a quartz glass substrate having a thickness of 1.1 mm by sputtering. Photosensitive resin (resist) having a thickness of 5000 Å was applied onto the AlTi alloy thin film by the spin-coating method, then, using a photomask, a resist film in a matrix shape with a width of 4 μm and a pitch of 26 μm was formed.

Then, the glass substrate formed with this matrix-shaped resist film was immersed in a mixed solution of phosphoric acid and nitric acid to etch the AlTi alloy thin film, then immersed in an alkaline aqueous solution to dissolve and remove the resist film.

Further, an ITO film was formed on the AlTi alloy pattern by sputtering under the condition of a substrate heating temperature 150° C., thereby to obtain an opposite substrate for a liquid crystal display panel.

The obtained opposite substrate for the liquid crystal display panel exhibited a reflectance of 92% from the glass surface, i.e. the surface of the opposite substrate at the light-incident side (reflectance of the glass substrate surface at the light-incident side+reflectance of the AlTi alloy thin film surface at the light-incident side).

Then, as a result of observation using a metallurgical microscope after a heat test at 120° C. for 500 hours, it was confirmed that no pinholes occurred in the AlTi alloy thin film.

### EXAMPLE 8

<AlTi/CrO>

An AlTi alloy thin film containing 0.5 at % of Ti with a thickness of 300 Å was formed on a quartz glass substrate having a thickness of 1.1 mm by sputtering, then a Cr oxide thin film having a thickness of 800 Å was formed by sputtering.

Photosensitive resin (resist) having a thickness of 5000 Å was applied onto the glass substrate by the spin-coating method, then, using a photomask, a resist film in a matrix shape with a width of 4 μm and a pitch of 26 μm was formed.

Then, the glass substrate formed with this matrix-shaped resist film was immersed in a ferric chloride solution to etch the Cr oxide thin film, then in a mixed solution of phosphoric acid and nitric acid to etch the AlTi alloy thin film, and then immersed in an alkaline aqueous solution to dissolve and remove the resist film.

Then, an ITO film was formed on the AlTi alloy/Cr oxide pattern by sputtering under the condition of a substrate heating temperature 150° C., thereby to obtain an opposite substrate for a liquid crystal display panel.

The obtained opposite substrate for the liquid crystal display panel exhibited a reflectance of 87% from the glass surface, i.e. the surface of the opposite substrate at the light-incident side (reflectance of the glass substrate surface at the light-incident side+reflectance of the AlTi alloy thin film surface at the light-incident side), and a reflectance of 12% from the surface where the Cr oxide thin film was formed.

Then, as a result of observation using a metallurgical microscope after a heat test at 120° C. for 500 hours, it was confirmed that no pinholes occurred in the AlTi alloy thin film.

### EXAMPLE 9

<AlTi/Cr Continuous Film>

An AlTi alloy thin film containing 0.5 at % of Ti with a thickness of 300 Å was formed on a no-alkali glass substrate (NA35: produced by NH Techno Glass Corporation) having a thickness of 1.1 mm by an in-line sputtering apparatus, then a Cr thin film having a thickness of 800 Å was formed. Upon observing a change in composition based on the Auger analyzing method, it was confirmed that the AlTi alloy thin film and the Cr thin film formed a continuous film whose composition changed continuously.

A target used in the sputtering was a 6-inch width target wherein AlTi (Ti: 0.5 at %) was provided in a 2-inch width on a substrate carry-in side, and Cr was provided in a 4-inch width on a substrate carry-out side.

Photosensitive resin (resist) having a thickness of 5000 Å was applied onto the glass substrate after the film formation by the spin-coating method, then, using a photomask, a resist film in a matrix shape with a width of 4 μm and a pitch of 26 μm was formed.

Then, the glass substrate formed with this matrix-shaped resist film was immersed in a Cr etching liquid (HY liquid produced by Wako Pure Chemical Industries, Ltd.) to etch Cr, then in a mixed solution of phosphoric acid and nitric acid to etch AlTi alloy, and then immersed in an alkaline aqueous solution to dissolve and remove the resist film.

Then, an ITO film was formed on the AlTi alloy/Cr pattern by sputtering under the condition of a substrate heating temperature 150° C., thereby to obtain an opposite substrate for a liquid crystal display panel.

The obtained opposite substrate for the liquid crystal display panel exhibited a reflectance of 88% from the glass surface, i.e. the surface of the opposite substrate at the light-incident side (reflectance of the glass substrate surface at the light-incident side+reflectance of the AlTi alloy thin film surface at the light-incident side), and a reflectance of 36% from the surface where the Cr thin film was formed.

Then, as a result of observation using a metallurgical microscope after a heat test at 120° C. for 500 hours, it was confirmed that no pinholes occurred in the AlTi alloy thin film.

Further, it was confirmed that the obtained pattern section had essentially no steps and was quite excellent.

### EXAMPLE 10

<AlTi/CrN Continuous Film>

An AlTi alloy thin film containing 1.0 at % of Ti with a thickness of 100 Å was formed on a no-alkali glass substrate (NA35: produced by NH Techno Glass Corporation) having a thickness of 1.1 mm using an in-line sputtering apparatus, then a Cr nitride thin film having a thickness of 1200 Å was formed. In this event, a target used in the sputtering included an AlTi (Ti: 1.0 at %) target and a Cr target that were disposed adjacently to each other at an interval of one inch therebetween, and the sputtering was performed while flowing Ar gas containing nitrogen from a substrate carry-out side. Upon observing a change in composition based on the Auger analyzing method, it was confirmed that the AlTi alloy thin film and the Cr nitride thin film formed a continuous film whose composition changed continuously.

Photosensitive resin (resist) having a thickness of 5000 Å was applied onto the glass substrate after the film formation by the spin-coating method, then, using a photomask, a resist film in a matrix shape with a width of 4 μm and a pitch of 26 μm was formed.

Then, the glass substrate formed with this matrix-shaped resist film was immersed in a Cr etching liquid (HY liquid produced by Wako Pure Chemical Industries, Ltd.) to etch the Cr nitride thin film, then in an alkaline aqueous solution to dissolve and remove the resist film and simultaneously etch the AlTi alloy thin film.

Then, an ITO film was formed on the AlTi alloy/Cr nitride pattern by sputtering under the condition of a substrate heating temperature 150° C., thereby to obtain an opposite substrate for a liquid crystal display panel.

The obtained opposite substrate for the liquid crystal display panel exhibited a reflectance of 85% from the glass surface, i.e. the surface of the opposite substrate at the light-incident side (reflectance of the glass substrate surface at the light-incident side+reflectance of the AlTi alloy thin film surface at the light-incident side), and a reflectance of 12% from the surface where the Cr nitride thin film was formed.

Then, as a result of observation using a metallurgical microscope after a heat test at 120° C. for 500 hours, it was confirmed that no pinholes occurred in the AlTi alloy thin film.

Further, it was confirmed that the obtained pattern section had essentially no steps and was quite excellent.

### Comparative Example 2

An Al thin film having a thickness of 100 Å was formed on a no-alkali glass substrate (NA35: produced by NH Techno Glass Corporation) having a thickness of 1.1 mm by sputtering, then a Cr thin film having a thickness of 1200 Å was formed by sputtering.

Photosensitive resin (resist) having a thickness of 5000 Å was applied onto the glass substrate after the film formation by the spin-coating method, then, using a photomask, a resist film in a matrix shape with a width of 4 μm and a pitch of 26 μm was formed.

Then, the glass substrate formed with this matrix-shaped resist film was immersed in a Cr etching liquid (HY liquid produced by Wako Pure Chemical Industries, Ltd.) to etch the Cr thin film, then in a mixed solution of phosphoric acid and nitric acid to etch the Al thin film, and finally immersed in an alkaline aqueous solution to dissolve and remove the resist film.

Then, an ITO film was formed on the Al/Cr pattern by sputtering under the condition of a substrate heating temperature 150° C., thereby to obtain an opposite substrate for a liquid crystal display panel.

The obtained opposite substrate for the liquid crystal display panel exhibited a reflectance of 50% from the glass surface, i.e. the surface of the opposite substrate at the light-incident side (reflectance of the glass substrate surface at the light-incident side+reflectance of the Al thin film surface at the light-incident side), and a reflectance of 60% from the surface where the Cr thin film was formed.

Then, as a result of observation using a metallurgical microscope after a heat test at 120° C. for 500 hours, it was confirmed that many pinholes having diameters of about 0.5 to 1.0 μm occurred in the Al thin film.

Further, upon observing the pattern shape using an electron microscope, it was confirmed that the roughness exceeding 1 μm was generated.

### EXAMPLE 11

A glass substrate on which concave portions were formed by isotropic etching, and a cover glass substrate were prepared. Positions and the number of the concave portions and a curved surface of the bottom wall of each concave portion were adjusted in advance such that the focus of each of below-noted microlenses is located at the center of a corresponding opening of a matrix-shaped light-shielding film. The glass substrate and the cover glass substrate were joined together with high refraction resin filled in between the surface of the glass substrate where the concave portions were formed and the cover glass substrate, thereby to form many microlenses, so that a microlens substrate forming a microlens array was prepared.

A matrix-shaped light-shielding film and an ITO film were formed on the microlens substrate on the side of the cover glass substrate according to the same method as used in Example 10, thereby to prepare an opposite substrate with the microlens substrate.

Then, as a result of observation using a metallurgical microscope after a heat test at 120° C. for 500 hours, it was confirmed that no pinholes occurred in the AlTi alloy thin film.

Further, it was confirmed that the obtained pattern section had essentially no steps and was quite excellent.

A liquid crystal display panel was fabricated using such an opposite substrate with the microlens substrate. Then, no malfunction occurred and a bright and excellent screen was obtained.

What is claimed is:

1. An opposite substrate for use in a liquid crystal display panel including a driving substrate having a plurality of pixel electrodes and a plurality of switching elements for switching said plurality of pixel electrodes, respectively, the opposite substrate disposed so as to confront said driving substrate with a predetermined gap therefrom, and liquid crystals retained in said predetermined gap,
said opposite substrate comprising a light-transmitting substrate and a light-shielding film, said light-shielding film formed on said light-transmitting substrate at least in one or both of regions corresponding to said switching elements and regions corresponding to driving circuits for driving said liquid crystal display panel,
wherein said light-shielding film comprises a member having a high reflectance, on a side thereof facing said light-transmitting substrate, and a member having a low reflectance as compared with the member having the high reflectance, on a side thereof facing said driving substrate, and
wherein, between a portion constituted of the member having the high reflectance and a portion constituted of the member having the low reflectance, a portion is provided where the member having the high reflectance and the member having the low reflectance exist mixedly.

2. The opposite substrate according to claim 1, wherein, in said portion where the member having the high reflectance and the member having the low reflectance exist mixedly,
a component of the member having the high reflectance decreases stepwise and/or continuously in a direction from the side of said light-transmitting substrate toward the side of said driving substrate, or
a component of the member having the low reflectance increases stepwise and/or continuously in said direction, or
a component of the member having the high reflectance decreases stepwise and/or continuously in said direction and a component of the member having the low reflectance increases stepwise and/or continuously in said direction.

3. The opposite substrate according to claim 1, wherein said light-shielding film is a film in which a component of the member having the high reflectance and a component of the member having the low reflectance change in composition continuously.

4. The opposite substrate according to claim 1, wherein a main component of the member having the high reflectance is Al, while a main component of the member having the low reflectance is Cr and/or Ni.

5. The opposite substrate according to claim 1, wherein oxygen and/or nitrogen is contained in the member having the low reflectance, on a side thereof facing said driving substrate.

6. The opposite substrate according to claim 5, wherein, in the member having the low reflectance, said oxygen and/or nitrogen decreases continuously in a direction from the side of said driving substrate toward the side of said light-transmitting substrate.

7. The opposite substrate according to claim 1, wherein a reflectance of the member having the high reflectance is 70% or greater, and a reflectance of the member having the low reflectance is 30% or less.

8. The opposite substrate according to claim 1, wherein a substrate formed with microlenses is provided on a side of said light-transmitting substrate from which light enters the opposite substrate, and wherein said microlenses are formed so as to project said light to said pixel electrodes, respectively.

9. A liquid crystal display panel produced by using the opposite substrate according to claim 1.

10. A method of fabricating an opposite substrate for use in a liquid crystal display panel including a driving substrate having a plurality of pixel electrodes and a plurality of switching elements for switching said plurality of pixel electrodes, respectively, the opposite substrate disposed so as to confront said driving substrate with a predetermined gap therefrom, and liquid crystals retained in said predetermined gap,
wherein said opposite substrate comprises a light-transmitting substrate and a light-shielding film, said light-shielding film formed on said light-transmitting substrate at least in one or both of regions corresponding to said switching elements and regions corresponding to driving circuits for driving said liquid crystal display panel, and
wherein said light-shielding film comprises a member having a high reflectance, on a side thereof facing said light-transmitting substrate, and a member having a low reflectance as compared with the member having the high reflectance, on a side thereof facing said driving substrate,
said method comprising:
a light-shielding film forming step of forming the member having the high reflectance and the member having the low reflectance continuously on said light-transmitting substrate by sputtering, and further forming, between the member having the high reflectance and the member having the low reflectance, a portion in which sputtering particles for forming the member having the high reflectance and sputtering particles for forming the member having the low reflectance are formed into a film in a superposed fashion.

11. The method according to claim 10, further comprising:
a step of forming a photosensitive resin film on said light-shielding film after said light-shielding film forming step;
a step of patterning said photosensitive resin film by photolithography to form a photosensitive resin film pattern; and
a light-shielding film pattern forming step of patterning the member having the low reflectance using said photosensitive resin film pattern as a mask, then removing said photosensitive resin film using an alkaline solvent and simultaneously etching the member having the high reflectance using the member having the low reflectance as a mask, thereby to form a matrix-shaped light-shielding film pattern.

12. The method according to claim 11, wherein the member having the high reflectance is made of Al or an Al alloy, and the member having the low reflectance is made of Cr or a Cr alloy.

13. A method of fabricating a liquid crystal display panel, wherein the liquid crystal display panel is fabricated using the opposite substrate obtained by the fabricating method according to claim 12.

14. An opposite substrate for use in a liquid crystal display panel including a driving substrate having a plurality of pixel electrodes and a plurality of switching elements for switching said plurality of pixel electrodes, respectively, the opposite substrate disposed so as to confront said driving substrate with a predetermined gap therefrom, and liquid crystals retained in said predetermined gap,
said opposite substrate comprising a light-transmitting substrate and a light-shielding film, said light-shielding film formed on said light-transmitting substrate at least in one or both of regions corresponding to said switching elements and regions corresponding to driving circuits for driving said liquid crystal display panel,
wherein said light-shielding film comprises a metal thin film at least on a side thereof facing said light-transmitting substrate, and
wherein said metal thin film contains an element for suppressing generation of migration.

15. The opposite substrate according to claim 14, wherein said element for suppressing the generation of the migration is at least one selected from the group consisting of Ti, Cu and Si.

16. The opposite substrate according to claim 14, wherein the content of said element for suppressing the generation of the migration in said metal thin film falls within a range of 0.1 to 5 at %.

17. The opposite substrate according to claim 14, wherein said metal thin film is a high reflection film having a high reflectance for suppressing a malfunction of the liquid crystal display panel, said malfunction caused by absorption by said light-shielding film of incident light entering the opposite substrate.

18. The opposite substrate according to claim 17, wherein said high reflection film contains an Al alloy and/or an Ag alloy.

19. The opposite substrate according to claim 17, wherein said light-shielding film comprises a low reflection film on a side thereof facing said driving substrate, said low reflection film having a reflectance lower than that of said high reflection film.

20. The opposite substrate according to claim 19, wherein said low reflection film is made of one of Ti, Cr, W, Ta, Mo, Pb, an oxide of each of said elements, a nitride of each of said elements, an oxide-nitride of each of said elements, an oxide of a high melting point metal silicide of each of said elements, a nitride of a high melting point metal silicide of each of said elements, and an oxide-nitride of a high melting point metal silicide of each of said elements.

21. The opposite substrate according to claim 17, wherein said high reflection film and said low reflection film form a continuous film whose composition changes continuously.

22. The opposite substrate according to claim 14, wherein, with respect to said light-transmitting substrate, a substrate formed with microlenses is provided on the side from which light enters the opposite substrate, and said microlenses are formed such that said light is projected to said pixel electrodes.

23. A liquid crystal display panel comprising the opposite substrate claimed in claim 14.

24. A liquid crystal projector manufactured by the use of the liquid crystal display panel claimed in claim 9.

25. A liquid crystal projector manufactured by the method claimed in claim 13.

26. A liquid crystal projector manufactured by the use of the liquid crystal display panel.
